(19) United States
(12) Patent Application Publication
(10) Pub. No.: US 2026/0330298 A1
(43) Pub. Date: Oct. 22, 2026

(54) REASONING-SEQUENCE DIRECT-PREFERENCE OPTIMIZATION OF A MULTIMODAL MACHINE-LEARNED MODEL

(71) Applicants: Bytedance Technology Ltd., Grand Cayman (KY); TSINGHUA UNIVERSITY, BEIJING (CN)

(72) Inventors: Guangzhi SUN, London (GB); Yudong YANG, Beijing (CN); Jimin ZHUANG, Beijing (CN); Changli TANG, Beijing (CN); Yixuan LI, Beijing (CN); Wei LI, Singapore (SG); Zejun MA, Beijing (CN); Chao ZHANG, Beijing (CN)

(21) Appl. No.: 19/186,511

(22) Filed: Apr. 22, 2025

(51) Int. Cl. G06N 20/00

(52) U.S. Cl. CPC G06N 20/00

(57) ABSTRACT

This document discloses a technology for implementing a reasoning-sequence direct-preference optimization of a multimodal machine-learned (ML) model. With the technology described herein, a ML model is used to produce a sequence of reasoning steps based on a question-answer pair about multimodal content (e.g., video). From selected original steps within that sequence, alternative versions of those steps are generated, while maintaining their relative position. The technology described herein performs multiple rollouts for each alternative and its original counterpart steps, determines the success of each rollout, and calculates comparative success rates. By establishing preferences based on these success rate comparisons, the technology described herein updates the ML model to prefer the more successful reasoning approaches.

### BACKGROUND

A multimodal Large Language Model (LLM) is an artificial intelligence (AI) system that can recognize and process multiple content input types, such as text, images, audio, and/or video, within a single unified model. Traditional LLMs are pretrained on natural language corpuses, question-answer pairs, and grounding sources, to generate concise and grammatically correct human-like natural language responses that answer questions in user queries, often with footnotes to relied-upon sources. Chain-of-reasoning LLMs recently have been developed that are able to first formulate a sequence of reasoning steps for answering a user query with answers to later reasoning steps depending on answers to prior reasoning steps. After the chain of reasoning steps is generated, the LLM sequentially generates intermediate answers to each of the reasoning steps, taking into account answers at prior steps, in order to generate a final answer. This step-by-step approach structures the reasoning process in a chained sequence, creating a logical pathway from question to answer. Extended to multimodal inputs, such reasoning capabilities allow models to pay attention to specific cues across the multiple modes of input at appropriate stages of the reasoning process. This can enable a model to reason based on disparate cues found in the audio and visual content of a video, for example.

### SUMMARY

The present disclosure is directed to computing systems and methods for reasoning-sequence direct-preference optimization of a multimodal machine-learned (ML) model. As described herein, a ML model is used to produce a sequence of reasoning steps based on a question-answer pair about multimodal content (e.g., video). From selected original steps within that sequence, alternative versions of those steps are generated, while maintaining their relative position. The systems and methods described herein perform multiple rollouts for each alternative and its original counterpart steps, determine the success of each rollout, and calculate comparative success rates. By establishing preferences based on these success rate comparisons, the systems and methods described herein update the ML model to prefer the more successful reasoning approaches.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The present disclosure of computing systems and methods for a reasoning-sequence direct-preference optimization of a multimodal machine-learned (ML) model is described with reference to the following drawings. The same numbers are used throughout the drawings to reference like features and components.

FIG. 1 illustrates a schematic view of an operating environment for a computing system in accordance with an example of the present disclosure.

FIG. 2 illustrates a schematic view of a reasoning-sequence direct-preference optimization component of the computing system of FIG. 1.

FIG. 3 illustrates a schematic view of a contrastive step selection component and alternative-step production component of the computing system of FIG. 1.

FIG. 4 illustrates a schematic view of an implementation of a computing system with a machine-learned model that has been updated in accordance with an example of the present disclosure.

FIG. 5 is a flow chart of an example method for reasoning-sequence direct-preference optimization according to an example embodiment of the present disclosure.

FIG. 6 is a flow chart of an example method for updating the machine-learned model according to an example embodiment of the present disclosure.

FIG. 7 shows a flowchart of an example method performing contrastive step selection according to an example embodiment of the present disclosure.

FIG. 8 shows a flowchart of an example method performing inference using an updated machine-learned model according to an example embodiment of the present disclosure.

FIG. 9 schematically shows a non-limiting embodiment of a computing system that can enact one or more of the methods and processes described herein.

### DETAILED DESCRIPTION

In some embodiments, the methods and processes described herein may be tied to a computing system of one or more computing devices. Such methods and processes may be implemented as a computer-application program or service, an application-programming interface (API), a library, and/or other computer-program product.

Computing systems and methods are described herein as implementing a reasoning-sequence direct-preference optimization of a multimodal machine-learned (ML) model. The computing systems and methods described herein optimizes the reasoning of the ML model about multimodal content by generating a sequence of reasoning steps for question-answer pairs about multimodal content (e.g., videos), determining a preference for potential alternative steps at the same position in the sequence based on calculated success rates for such steps, and updating the ML model to prefer the sequence with the steps that demonstrate better success rates than the other steps.

The technology described herein effectively reinforces more successful reasoning approaches by systematically comparing potential reasoning steps and updating preference-based model models. Compared to typical approaches, the technology described herein dramatically improves the ability of an ML model to reason about multimodal content. This enables more accurate, explainable analysis without prohibitive computational resources for evaluating every possible reasoning step.

Machine-learning (ML) models are computer systems trained on data to learn patterns and make predictions or decisions without being explicitly programmed for each specific task. Neural networks and diffusion models are examples of ML models. A Large Language Model (LLM) is a specific type of ML model. LLMs use transformer architectures and attention mechanisms to excel at translation, summarization, and question-answering tasks. Multimodal Large Language Models (M-LLMs) are LLMs that can recognize and process multiple content types simultaneously-unlike traditional LLMs, which only work with text. Examples of content types include text, images, audio, or video. A M-LLM can be configured to receive inputs in a plurality of modes and/or to generate output in a plurality of modes.

These M-LLMs use specialized encoders for various input types that feed into a unified system, enabling them to make connections across various modes of information. For instance, M-LLMs can analyze the visuals of a video along with its accompanying audio.

Chain-of-Thought Reasoning (CoTR) is an approach to enhance machine-learning models to reason about complex problems through a series of intermediate reasoning steps. Herein, a machine-learning model that is capable of CoTR may be called “reasoning-enhanced.” Unlike traditional approaches where the models produce answers directly, CoTR machine-learning models break down their problem-solving into logical steps that go from an initial question to the answer. This step-by-step process mimics human reasoning and can potentially make the decision-making process of the model more explainable.

CoTR machine-learning models produce reasoning paths using a sequence of interconnected steps. Every step is built on the previous ones, creating a chain of reasoning from the input query to the solution. This structuring approach enables models to tackle difficult tasks that require multi-step reasoning, and the models become more capable of solving problems that require logical deduction, mathematical computation, or causal reasoning.

While CoTR machine-learning models have demonstrated improvements in text-based reasoning tasks such as mathematics and coding problems, their application to multimodal inputs presents particularly difficult challenges. Typical M-LLMs generate answers directly without showing intermediate reasoning steps when processing video content. This direct approach limits their effectiveness in complex video analysis scenarios where explicit reasoning about the relationships between audio and visual elements would be helpful.

For video analysis, typical M-LLMs can struggle to explain temporal relationships, reason about cross-modal interactions between visual and auditory information, or detect fine-grained anomalies. Such limitations are further pronounced when they are applied to use cases where strong content understanding is involved, such as educational lectures, conversational dialogue, or synthetic video detection. Lacking step-by-step reasoning in video analysis constrains the ability to correctly process, by the model, high-level multimodal inputs and reduces the explainability of its inference.

Process Reward Models (PRMs) have addressed reasoning challenges in multimodal content analysis, particularly for enhancing step-by-step reasoning in M-LLMs. PRMs estimate absolute correctness scores for individual reasoning steps, predicting how likely each step will lead to a correct final answer. However, PRMs face significant limitations when applied to complex audio-visual content. PRMs struggle with ambiguous evaluation standards across different modalities and require separate reward model architectures that add computational overhead. PRMs also typically necessitate two-pass re-ranking pipelines where multiple reasoning paths must be entirely generated before selecting the best one.

The technology described herein overcomes these shortcomings by replacing absolute scoring with direct preference comparisons between alternative reasoning steps, eliminating the need for separate reward models and enabling more efficient, targeted optimization of the specific reasoning steps most insightful to multimodal understanding. The technology described herein performs step-level reward modelling tailored for multimodal content input.

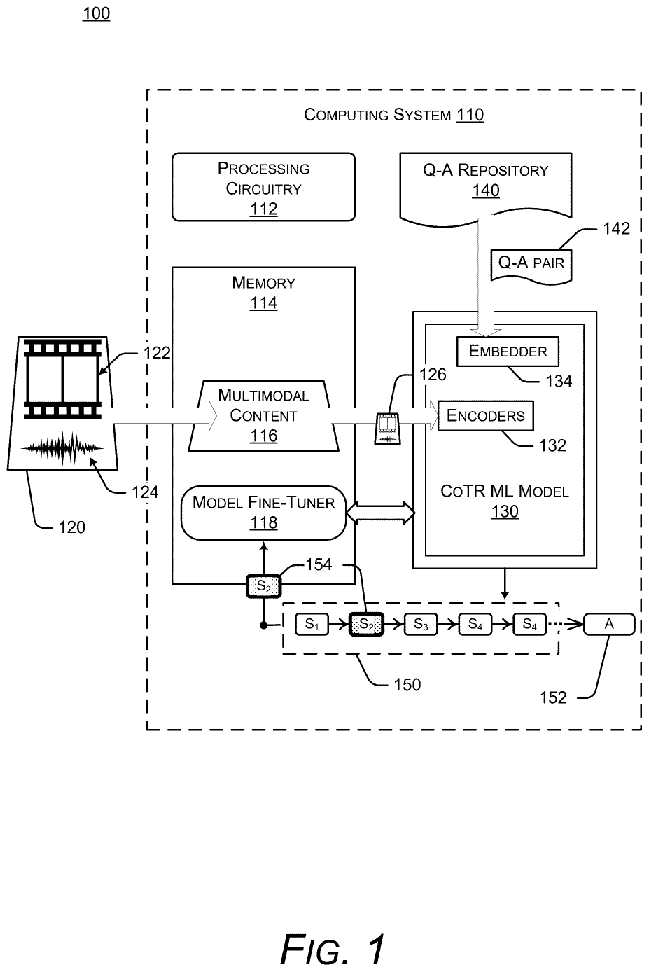

FIG. 1 illustrates a schematic view of an operating environment 100 for a computing system in accordance with an example of the present disclosure. The operating environment 100 includes a computing system 110 with processing circuitry 112, memory 114, a pre-trained (e.g., trained) multimodal CoTR (e.g., reasoning-enhanced) machine-learned (ML) model 130, and a Q-A repository 140. Within the operating environment 100, the already trained ML model 130 is further trained (e.g., “fine-tuned”) using an implementation of reasoning-enhanced direct-preference optimization, as described herein.

The memory 114 stores multimodal content 116, which may be acquired, as depicted, from an external content source 120. That is, the external content source 120 is not part of the computing system 110. Examples of the external content source 120 may be wired or wireless input from a camera, keyboard, microphone, and the like. Other examples include wired or wireless connected computer system, server, and the so-called cloud (e.g., the Internet). The external content source 120 supplies multimodal content, which is a video having both visual content 122 and corresponding audio content 124. In other implementations, the multimodal content may include still images, text, and the like.

As depicted, a video clip 126 is extracted from the multimodal content 116 in the memory 114 and supplied to the CoTR ML model 130 as input. This video clip 126 includes both visual information (e.g., visual frames of a video) along with corresponding audio information.

The Q-A repository 140 is a curated dataset of text-based question-answer pairs about multimodal content, such the multimodal content 116. Each Q-A pair of the Q-A repository 140 includes text-based content having a query about multimodal content and its corresponding correct answer.

During training and fine-tuning described herein, these Q-A pairs provide both the initial prompt and the reference answer against which reasoning success is measured. For training purposes, for example, the Q-A repository 140 may include hundreds of thousands of typical Q-A pairs and perhaps tens of thousands of reasoning-intensive Q-A pairs specifically designed to challenge the reasoning capacity of the ML model.

As depicted, a Q-A pair 142 is an example of a Q-A pair extracted from the Q-A repository 140 and supplied to the CoTR ML model 130 as input. Examples of the questions and answers that may be included in the Q-A pair 142 include:
1. Q: How many people appear in the video? A: Three.
2. Q: Is there background music? A: Yes.
3. Q: What is the main activity shown? A: Cooking.
4. Q: Are the hand movements natural? A: No.
5. Q: Does the face show realistic emotions? A: No.
6. Q: Does the voice match the speaker's lip movements? A: Yes.
7. Q: Is the person speaking the same language as the subtitles? A: No.

The CoTR ML model 130, as show n, includes multimodal encoders 132 that receives and encodes the input of the video clip 126 and text-based embedder 134 that receives and embeds the text-based Q-A pair 142.

The text-based embedder 134 transforms the Q-A pairs (such as Q-A pair 142) into vector representations called text embeddings before further processing by the CoTR ML model 130. These text embeddings capture semantic meaning through numerical values. Because of this, the model can perform mathematical operations on textual content of the Q-A pair 142.

Initially, the text passes through tokenization, breaking questions and answers into smaller units. Next, these tokens convert to vector representations which align dimensionally with audio-visual embeddings through projection layers. During processing, text embeddings combine with multimodal embeddings in a synchronized sequence. For instance, a question about video content becomes positioned at the beginning of the input sequence. Meanwhile, the answer embeddings serve multiple functions: training targets during supervised fine-tuning, evaluation benchmarks during rollouts, and reference points for calculating success rates.

Additionally, the embedding space facilitates cross-modal attention mechanisms where textual elements can directly reference visual or audio features. This unified representation ultimately allows the model to reason across modalities, connecting questions to answers through logically coherent steps based on multimodal evidence.

The multimodal encoders 132 include at least a visual (e.g., video frames) encoder and an audio encoder, as separate encoders. With these two encoders, the multimodal encoders 132 separately process the audio information and the visual information of the video clip 126 to extract modality-specific features as audio embeddings and visual embeddings. These embeddings represent the audio and visual content in high-dimensional vector spaces. These feature embeddings are then transformed by dedicated modality aligners into a standardized format compatible with the CoTR ML model 130. This separation-then-alignment approach enables optimal processing of each modality (e.g., visual and audio embeddings) before combining them for unified reasoning by the CoTR ML model 130.

The CoTR ML model 130 performs interleaved synchronization to combine the audio and visual encodings. The groups of encodings per visual frame are equally spaced across time, and the audio encodings corresponding to the time between two visual frames t₁ and t₂ are inserted between the two groups of visual encodings. The interleaved synchronization technique is summarized as in Equation 1:

$${H}^{AV} = Concat ( … , {H}_{t 1}^{V} , {H}_{t 1 : t 2}^{A} , {H}_{t 2}^{V} , … ) \qquad Equation 1$$

where H^{A}ϵR^{m×d} and H^{V}ϵR^{n×d} represent groups of audio and visual encodings, and m and n are the number of encodings in each group.

With the technology described herein, the CoTR ML model 130 is already trained using a training corpus of multimodal content (such as that found in external source 120) and a wealth of Q-A pairs (such as Q-A pair 142) in the Q-A repository 140. In some instances, the CoTR ML model 130 may have been trained using a multi-stage training approach with distinct phases targeting different model components.

Initially, Supervised Fine-Tuning (SFT) may be employed. In so doing, the SFT may use cross-entropy loss to measure differences between predicted outputs and reference responses. This may begin with a pre-trained visual model that has already learned from large datasets. Subsequently, an audio aligner may undergo training from scratch while other components remain fixed (e.g., “frozen”). This focused approach conserves computational resources. Once the audio component reaches sufficient performance, the training may advance to include modality aligners and Low-Rank Adaptation (LoRA) modules.

After completing the SFT stages, Reinforcement Learning (RL) techniques may be employed to further refine the reasoning capabilities the CoTR ML model 130. LoRA adds small trainable matrices to existing weights rather than modifying all parameters, thus enabling efficient fine-tuning. Throughout these stages, paired audio-video information provides synchronized content for learning cross-modal relationships. The modality aligners, meanwhile, transform features from different input types into standardized formats compatible with language processing. As a result of this sequential methodology, the CoTR ML model 130 gradually builds multimodal understanding while maintaining computational efficiency. Finally, the completely trained system integrates all components for comprehensive audio-visual reasoning across various tasks.

While shown separate from the memory 114, the CoTR ML model 130 and the Q-A repository 140 may be implemented as stored data and/or instructions in the memory 114 that, when executed, that, when executed, cause the processing circuitry 112 execution the functions of the CoTR ML model 130 and the Q-A repository 140.

The memory 114 also stores a model fine-tuner 118, which is a program module that stores instructions that, when executed, cause the processing circuitry 112 to fine-tune the pre-trained multimodal CoTR ML model 130. Using the already trained CoTR ML model 130, the fine-tuner 118 produces a sequence 150 of reasoning steps (S₁, S₂, S₃, S₄, S₅) based on a question-answer pair (e.g., the Q-A pair 142) about the multimodal content 116 that connects the question to the answer. Formulaically, the reasoning process of the CoTR ML model 130 may be described as generating the Q→{S₁, S₂, . . . , Sₖ}→A sequence, where Q is the question, A is the answer and Sₖ are reasoning steps that logically connect the question Q to the final answer A.

The reasoning steps of the sequence 150 produced by the model are shown in a dashed box. The steps themselves are shown in small boxes with left-to-right flow arrows therebetween. Each step in the sequence 150 has a defined position in the sequence. For example, the steps are identified as S₁, S₂, S₃, S₄, and S₅, which indicate steps one through 5 in that order. Thus, After S₅ is an ellipse (“ . . . ”) that indicates that other steps may be part of the sequence but are not shown. Following the logical flow of the reasoning steps in order leads to its answer 152, which is identified as A. While shown separate from the memory 114, the sequence 150 and its answer 152 may be implemented as data stored in the memory 114 or, perhaps, another non-depicted memory or storage.

At least in part, the technology described herein optimizes the reasoning of the CoTR ML model 130. Broadly, this is accomplished using reinforcement learning by treating the reasoning process as a Markov Decision Process (MDP). In this mathematical framework, each reasoning step represents a state where decisions depend only on the current situation, not the entire history. The CoTR ML model 130 functions as a decision-maker that determines which reasoning step to generate next based on the current state.

Meanwhile, a Process Reward Model (PRM) is employed to evaluate each step and provides numerical feedback indicating how likely that specific reasoning step will lead to a correct final answer. By adjusting the parameters of the CoTR ML model 130 to favor steps receiving higher reward signals, the fine-tuner 118 optimizes the decision-making to maximize expected rewards.

With the technology described herein, reasoning improvement may be treated like a mathematical optimization problem where the e CoTR ML model 130 learns to select steps with higher probability of success rather than simply matching training examples. The PRM effectively serves as the reward function in this reinforcement learning setup, guiding the CoTR ML model 130 toward increasingly effective reasoning strategies through increasing improvement based on anticipated outcome.

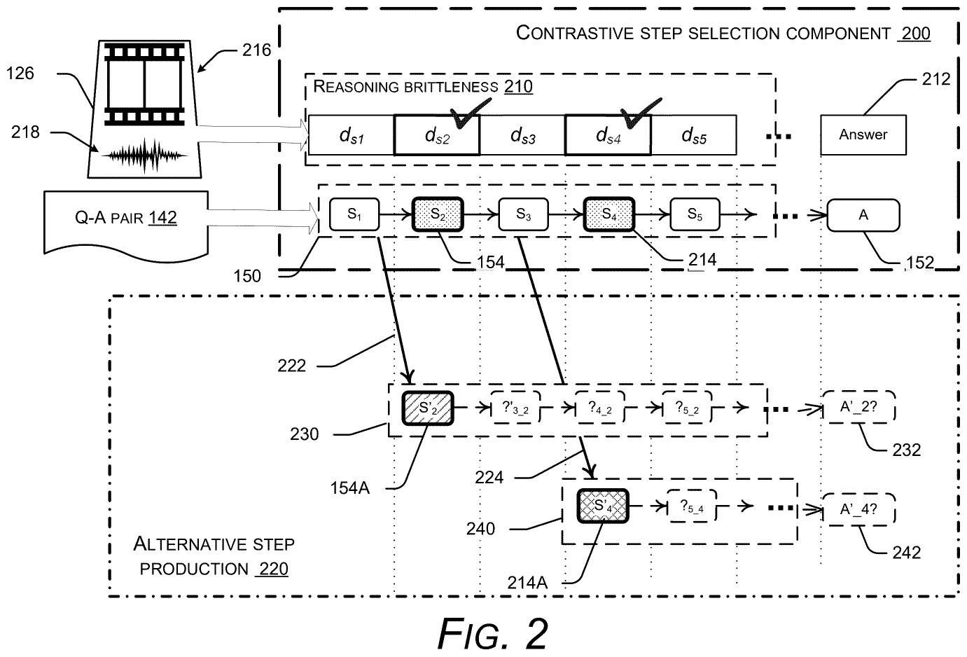

The fine-tuner 118 selects one or more original steps in the sequence 150 of reasoning steps to undergo reasoning-sequence direct-preference optimization. As noted above, each step has a defined position relative to the other steps in the sequence 150. The selected original steps retain that defined position in the sequence 150. The fine-tuner 118 employs a contrastive step selection component to perform selection of the original steps in the sequence 150. FIG. 2 and its accompanying discussion below provides the particular of the contrastive step selection component of the fine-tuner 118.

As depicted in FIG. 1, the fine-tuner 118 selects a single step as being the most brittle. The selected step is step S₂ 154 of the sequence 150. Thus, step S₂ 154 is the single original step selected in this depiction. This selection is illustrated by showing step S₂ 154 on an arrow directed from the sequence 150 to the fine-tuner 118. In addition, step S₂ 154 is shown with a distinctive shading pattern to visually distinguish it from the other non-selected steps in the sequence 150.

With the original steps selected, the fine-tuner 118 continues the reasoning-enhanced direct-preference optimization operations for each selected original step in the sequence 150. Thus, if only one original step is selected—like step S₂ 154 of the sequence 150—then these optimization operations are only performed once. If there are multiple original steps selected, then the optimization operations repeat or loop for each of those selected multiple steps.

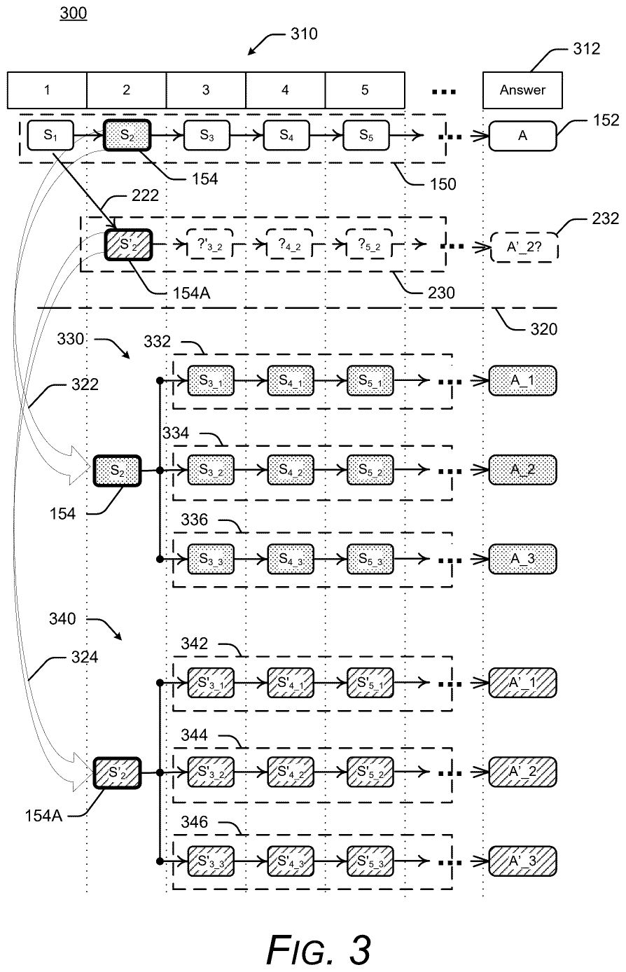

FIG. 3 and its associated discussion below covers the specifics of the continued operations of the reasoning-enhanced direct-preference optimization performed by the fine-tuner 118. As an overview, generally, the fine-tuner 118 generates one or more alternative reasoning steps that all share the same defined position in the sequence 150 as their corresponding original step.

Collectively, the one or more alternative steps and their corresponding original step form what is called a “step set,” herein. The members of a step set include an original step and one or more alternatives steps, which all occupy the same defined position in the reasoning sequence. For example, step S₂ 154 and its alternative steps occupy position two in the sequence associated with each step.

The fine-tuner 118 then executes multiple continuation paths (“rollouts”) starting from each member of the step set, following each potential reasoning branch to completion (e.g., answer). Each rollout receives a success evaluation based on whether it produced the correct answer.

The fine-tuner 118 calculates a success rate for each step in the step set by determining what percentage of its rollouts reached correct conclusions. These success rates undergo comparison to establish preference relationships among the steps occupying the same position in sequence 150, The higher success rates indicating more effective reasoning approaches.

The fine-tuner 118 then updates the parameters of the CoTR ML model 130 to increase the probability of generating the more successful reasoning steps when encountering similar problems in the future. This process effectively identifies and reinforces the reasoning patterns most likely to produce correct answers without requiring absolute scoring of individual steps.

FIG. 2 illustrates a schematic view of the function of the contrastive step selection component 200 and an alternative-step producer component 220 of the fine-tuner 118 of the computing system of FIG. 1. As they were depicted in FIG. 1, the sequence 150 of reasoning steps (S₁, S₂, S₃, S₄, S₅) are shown in a dashed box with their resulting answer 152. Answer 152, like the other answers to various reasoning paths shown in FIG. 2, falls under the under heading labeled Answer 212.

The contrastive step selection component 200 performs the selection of the original steps in the sequence 150. In doing so, it employs an input video (such as the video clip 126 that has visual information 216 and corresponding audio information 218) and a Q-A pair, such as Q-A pair 142. However, other implementations of the technology described herein may use other selection approaches.

In theory, all steps in the sequence 150 could be selected to be the original steps that undergo reasoning-sequence direct-preference optimization. However, computational constraints and limited resources make this approach impractical. In some instances, the step selection approach may include, for example, the following: random sampling of steps, fixed patterns (e.g., selecting every nth step), and focusing on early versus late steps in the reasoning-chain sequence.

The contrastive step selection component 200 of the fine-tuner 118 of the computing system 100 performs step selection based on the “reasoning brittleness” of a step, which is an indication of the reasoning process at a particular step exhibiting high sensitivity to input variations. That is, reasoning brittleness of a step indicates the sensitivity of the step to changes in reasoning relative to changes in the multimodal content.

With the reasoning-brittleness selection approach, the contrastive step selection component 200 of the fine-tuner 118 quantifies the susceptibility (e.g., reasoning brittleness) of each reasoning step to the input video (e.g., the video clip 126). The contrastive step selection component 200 determines the reasoning brittleness of steps of the sequence 150 by generation of modified multimodal content by applying perturbations to the multimodal content (e.g., the video clip 126).

To this end, the contrastive step selection component 200 applies small perturbations to the video clip 126. It may do this by producing (using the CoTR ML model 130) a set of modified reasoning steps based on the question-answer pair (e.g., Q-A pair 142) about modified multimodal content. Each modified step has a corresponding step in the sequence. This correspondence is seen in examining a “reasoning brittleness” segmented banner 210 for its associated steps of the sequence 150.

The “reasoning brittleness” segmented banner 210 lists the quantification of the reasoning brittleness for each step in the sequence 150. The label of the quantification of each reasoning brittleness is labeled above its corresponding step. As shown, dₛ₁ is associated with step S₂, dₛ₂ is associated with step S₂, dₛ₃ is associated with step S₃, dₛ₄ is associated with step S4₄, and dₛ₅ is associated with step S₅.

Herein, a perturbation refers to a small, deliberate modification applied to the video clip 126 to test how sensitive different reasoning steps are to input variations. Typically, these modifications are minor changes that do not fundamentally alter the meaning of the content but can reveal reasoning vulnerabilities.

For example, perturbations might include subtle alterations to pixel values, slight blurring, minor frame modifications, or small audio adjustments. When applied as part of the operations of the contrastive step selection component 200, these tiny changes help identify which reasoning steps experience the greatest output divergence in response to barely noticeable input differences. Steps with high divergence scores indicate areas where reasoning stability breaks down, often when processing visual details or temporal relationships.

The purpose of perturbations is to quantify “reasoning brittleness” by measuring how much an output distribution of a step changes when the input is slightly altered. Steps showing high sensitivity to perturbations are identified as reasoning brittle where reasoning stability breaks down, making them priority targets for optimization using the technology described herein.

The contrastive step selection component 200 compares the reasoning of the steps against the reasoning of the modified steps and determines a degree of change in reasoning of the steps against the modified steps. Thus, the contrastive step selection component 200 measures which reasoning steps exhibit the largest changes in output distribution. The reasoning brittleness of a step is measured based on length-normalized per-token computing a Kullback-Leibler (KL) divergence of reasoning results between the modified step and a corresponding step in the sequence.

A KL divergence quantifies the statistical difference between two probability distributions. In this instance, the contrastive step selection component 200 of the fine-tuner 118 compares the output probabilities for each token when given original versus perturbed input. Here, each token in a reasoning step has its KL divergence calculated, then these values are summed and divided by the total length of the step to ensure fair comparison between shorter and longer reasoning steps. This normalization prevents longer steps from appearing more sensitive simply because they contain more tokens.

For each step Sₖ, the contrastive step selection component 200 computes the length-normalized KL-divergence by:

$${d}_{{s}_{k}} \frac{1}{\vert {s}_{k} \vert} {\sum }_{{y}_{i} ∈ {s}_{k}} {D}_{KL} ( P ( {y}_{i} \vert {y}_{< i} , {H}^{AV} ) ‖ P ( {y}_{i} \vert {y}_{< i} , {\tilde{H}}^{AV} ) ) , \qquad Equation 2$$

where D_{KL}(⋅) computes the KL-divergence between the output distributions with the original inputs H^{AV} and perturbed inputs \tilde{H}^{AV}. The dₛₖ of Equation 2 is the dₛₖ quantification of the reasoning brittleness for each step in the sequence 150 found in the reasoning-brittleness segmented banner 210.

A higher dₛₖ indicates that the reasoning step Sₖ is more susceptible to small input change, and this high susceptibility is likely to yield more diverged subsequent steps. The contrastive step selection component 200 selects the top T steps with the highest dₛₖ to perform pairwise rollout, where T may be a value of one or more, but typically less the k.

Research has shown that, generally, reasoning failures occur at steps where the model misinterprets or hallucinates visual content. By targeting these reasoning-brittle (e.g., high-divergence) steps for optimization, the contrastive step selection component 200 addresses the most error-prone parts of the reasoning process while reducing computational requirements.

The contrastive step selection component 200 labels the original steps as having most reasoning brittleness as the selected one or more original steps. That is, the contrastive step selection component 200 labels the original steps with a greatest degree of change (based on the KL divergence quantification) as the selected original steps.

For this example, presume that the top two most brittle steps are selected and further presume that dₛ₂ and dₛ₄ are the highest measured quantification of reasoning brittleness for the steps in the sequence 150. This measured quantification indicates that the steps associated therewith have the greatest degree of change (based on the KL divergence quantification).

Consequently, the contrastive step selection component 200 of the fine-tuner 118 selects the two steps that are associated with dₛ₂ and dₛ₄, which are steps S₂ 154 and S₄ 214. The selection of these steps is illustrated by each step having a distinctive shading pattern to visually distinguish it from the other selected step and the other non-selected steps in the sequence 150.

While FIG. 2 depicts the functioning of the alternative-step producer component 220, the details of the component will be discussed in the context of a reasoning-sequence direct-preference optimization as it is applied to each selected original step (e.g., steps S₂ 154 and S₄ 214) of the sequence 150, which is shown in FIG. 3 and its accompanying description below.

Generally, the alternative-step producer component 220 performs an initial operation of reasoning-sequence direct-preference optimization. The production of alternative steps leverages the generative capabilities of the CoTR ML model 130 to create different reasoning paths at targeted positions. The generation process uses the same question-answer pair (e.g., Q-A pair 142) that informed the steps of the sequence 150. This ensures alternative steps remain contextually relevant to solving the original problem.

For each selected original step (e.g., steps S₂ 154 and S₄ 214) of the sequence 150, the alternative-step producer component 220 produces one or more alternative steps that occupy the same position in the sequence 150. As depicted, there is only one alternative step produced for each of the two selected original step (e.g., steps S₂ 154 and S₄ 214) of the sequence 150. In other instances, there may be multiple alternatives produced for each selected original step.

For example, alternative step S′₂ 154A is part of a potential new sequence 230 of new steps (e.g., ?′_{3_2}, ?′_{4_2}, and ?′_{5_2}) that leads to a potential answer A′_2? at 232. These items are called “potential,” are shown in dashed lines, and include question mark because the new steps and the new sequence 230 have not be generated. Instead, they have the potential to be created based upon the newly generated alternative step S′₂ 154A. A rrow 222 points from step S₁ of the sequence 150 to the alternative step S′₂ 154A and indicates that step S₁ of the sequence 150 is preserved as part of the potential new sequence 230.

Similarly, alternative step S′₄ 214A is part of a potential new sequence 240 of new steps (e.g., ?′_{5_4}) that leads to a potential answer A′_4? at 242. Like above, these items are called “potential,” are shown in dashed lines, and include question mark because they have not been generated. A rrow 224 points from step S₃ of the sequence 150 to the alternative step S′₄ 214A and indicates that step S₃ and all of the previous steps of the sequence 150 are preserved as part of the potential new sequence 240.

Each alternative step offers a distinct approach to the reasoning at that specific step position while preserving the overall sequencing structure. Together with the original step, these alternatives form a “step set,” which include the selected original step and all its alternative steps (regardless of how many alternative steps there are). Thus, there is a step set for each selected original step. This approach enables the exploration of multiple reasoning pathways without disrupting the overall structure of the reasoning chain of the sequence 150.

FIG. 3 illustrates a schematic view of a reasoning-sequence direct-preference optimization component 300 of the fine-tuner 118 of the computing system of FIG. 1. For each selected original step (e.g., step S₂ 154), the optimization component 300 performs a series of operations.

Based on the question-answer pair (e.g., Q-A pair 142), the optimization component 300 produces one or more alternative steps (e.g., alternative step S′₂ 154A) that have a defined position in the sequence corresponding to an original step. The one or more alternative steps and the corresponding original step form a “step set.” These alternatives offer different reasoning approaches at the same sequence position while maintaining consistency with previous steps.

In FIG. 3, a segmented banner 310 with numbered segments that correspond to the defined position in the sequence (e.g., sequence 150) of each step is shown. A defined position in the sequence can be easily noted based on the numbered segment of the segmented banner 310 that the step falls under. As they were depicted in FIG. 1, the sequence 150 of reasoning steps (S₁, S₂, S₃, S₄, S₅) are shown in a dashed box with their resulting answer 152. Answer 152, like the other answers to various reasoning paths shown in FIG. 3, falls under the under heading labeled Answer 312.

As shown in FIG. 2, the potential new sequence 230 is also shown as part of the optimization component 300. The potential new sequence 230 includes alternative step S′₂ 154A followed by potential new steps (e.g., ?′_{3_2}, ?′_{4_2}, and ?′_{5_2}), which ultimately leads to a potential answer A′_2? at 232. These items have the potential to be created based upon the newly generated alternative step S′₂ 154A. Indeed, that potential will be realized forthwith with rollouts. Arrow 222 from step S₂ 154 of the sequence 150 to the alternative step S′₂ 154A indicates that step S₁ of the sequence 150 is preserved as part of the potential new sequence 230.

The optimization component 300 generates multiple rollouts for each step of the step set. These rollouts continue the reasoning sequence from each step in the step set through to completion. Rollouts may incorporate controlled randomness through temperature sampling to explore the distribution of possible outcomes. While a single rollout represents one possible future path, a collection of rollouts (called rollout bundle herein) provides statistical information about likely outcomes. All the rollouts of a rollout bundle start at the same origin step. Rollouts can vary in length depending on how many steps are needed to reach a conclusion, and their results provide empirical data about the expected value of different decision points.

Below long-short-short dashed line 320 are the rollouts based on the selected original step S₂ 154 and the alternative step S′₂ 154A. A rollout is a sampled trajectory that continues a reasoning sequence from a specific step (e.g., step S₂ 154 and alternative step S′₂ 154A) to its conclusion. Starting from a given position in a reasoning chain, the CoTR ML model 130 generates subsequent steps until reaching a final answer.

Two rollout bundles 330 and 340 are shown in FIG. 3. Each bundle includes three rollouts, but other implementations may have fewer or more rollouts per bundle. Rollout bundle 330 includes rollouts 332, 334, 336, which are derived from the same origin step: step S₂ 154. Note that curved arrow 322 shows that selected original step S₂ 154 as found in the sequence 150 is the basis of rollout bundle 330. Likewise, rollout bundle 340 includes rollouts 342, 344, 346, which are derived from the same origin step: step S′₂ 154A. Note that curved arrow 324 shows that the alternative step S′₂ 154A as found in the potential new sequence 230 is the basis of rollout bundle 340.

Each rollout of the rollout bundle 330 starts with S₂ 154. Rollout 332 continues step S3_1 at position 3 (see segmented banner 310), S4_1 at position 4, S5_1 at position 5, possibly more steps (as indicated by an ellipse), and concludes with answer A_1. Rollout 334 continues step S3_2 at position 3, S4_2 at position 4, S5_2 at position 5, possibly more steps (as indicated by an ellipse), and concludes with answer A_2. Rollout 336 continues step S3_3 at position 3, S4_3 at position 4, S5_3 at position 5, possibly more steps (as indicated by an ellipse), and concludes with answer A_3.

Each rollout of the rollout bundle 340 starts with S′2 154A. Rollout 342 continues step S′3_1 at position 3 (see segmented banner 310), S′4_1 at position 4, S′5_1 at position 5, possibly more steps (as indicated by an ellipse), and concludes with answer A′_1. Rollout 344 continues step S′3_2 at position 3, S′4_2 at position 4, S′5_2 at position 5, possibly more steps (as indicated by an ellipse), and concludes with answer A′_2. Rollout 346 continues step S′3_3 at position 3, S′4_3 at position 4, S′5_3 at position 5, possibly more steps (as indicated by an ellipse), and concludes with answer A′_3.

The optimization component 300 determines success of each rollout by evaluating whether the final answer generated at the conclusion of the rollout matches the reference answer from the question-answer pair (e.g., Q-A pair 142). This evaluation process involves comparing the semantic content of the generated answer with the established correct answer.

In some instances, the optimization component 300 may employ a simple binary approach to determine rollout success. An answer either matches the reference (success=1) or does not (success=0). This straightforward approach offers training signals and works efficiently across different question types. Other instances may use alternative approaches. For example, a graded scale could measure partial correctness. Semantic similarity metrics could evaluate answer closeness. Multi-criteria systems could assess both accuracy and reasoning quality. Other options include confidence-weighted scoring, distribution matching, and human evaluation integration.

The optimization component 300 calculates a success rate of each step of the step set by dividing successful rollouts by total rollouts for that step. This produces a probability estimate of how likely each reasoning approach is to reach the correct conclusion.

With one implementations, the calculation of a success rate of a step follows an empirical approach with a mathematical formulation, as shown here:

$${p}_{{s}_{k}} \approx \frac{1}{N} {\sum }_{n = 1}^{N} \text{?} ( {A}_{n} = {A}_{ref} ) \qquad Equation 3$$

where: pₛₖ represents the success rate (e.g., probability of success) for step Sₖ; N is the total number of rollouts performed for that step; Aₙ is the final answer generated by the nth rollout; Aref is the reference (e.g., correct) answer from the Q-A pair 142; and 1(Aₙ=A_{ref}) is an indicator function that equals 1 if the answer matches the reference and 0 otherwise.

For a selected step in the step set, the optimization component 300 performs N independent rollouts (e.g., 6-10). Each rollout continues the reasoning process from the step until reaching a final answer. For each rollout, the optimization component 300 evaluates whether the generated answer matches the reference answer (e.g., a binary determination). The optimization component 300 counts the number of rollouts that produced correct answers. This count is divided by the total number of rollouts N. The resulting value represents the empirical probability (between 0 and 1) that the reasoning step will lead to a correct answer.

The optimization component 300 compares the calculated success rate of the steps of the step set to identify which reasoning approaches are most effective based on the steps being compared. This establishes which step of the step set most reliably leads to correct answers.

Based on the calculated success rates, the optimization component 300 performs direct numerical comparisons between the steps of the step set. For any two steps in the step set (e.g., original step Sₖ and alternative step S′ₖ), the optimization component 300 performs a direct numerical comparison to determine which success rate is higher, calculates the arithmetic difference between the success rates (e.g., pₛₖ−p_{s′k}), and determines the magnitude of this difference, which indicates how much more successful one step is than another.

For step sets containing more than two steps, the optimization component 300 may conduct pairwise comparisons between all possible combinations of steps. This creates a complete ranking of steps based on their empirical success rates.

The comparison process is a mathematical operation that produces raw comparison results that identify which reasoning approaches starting at particular step position in the sequence are most likely to lead to correct answers, and by what margin.

Based on the raw comparison results, the optimization component 300 assigns preferences relative to the steps of the step set based on the comparison of the calculated success rate thereof. The higher success rates receiving stronger preference signals. These preferences may be represented preference values (αₖ), which may be hard values (e.g., 1 or 0) or soft values (e.g., ranging from 0 to 1) using a sigmoid normalization function that accounts for estimation uncertainty. To that end, the optimization component 300 may employ either a Basic Binary Preference (BBP) approach or a Soft Preference (SP) approach to establish preference values (αₖ) between steps based on these success rates.

With BBP approach, the optimization component 300 creates a hard decision based on which step has the higher success rate. The formula for this approach is as follows:

$${α}_{k} = \text{?} ( {p}_{{s}_{k}} > {p}_{{s}_{k}^{′}} ) \qquad Equation 4$$

where, αₖ is a preference value (either 0 or 1) for step k; 1( ) is an indicator function that returns 1 if the condition inside is true, and 0 otherwise; pk is the success rate of the original step Sₖ; pₛₖ is the success rate of the alternative step S′ₖ; and > is a comparison operator checking if the left value is greater than the right value.

The indicator function of Equation 4 equals 1 if steps Sₖ has a higher success rate than step S′ₖ, and 0 otherwise. The BBP approach provides clear, decisive training signals and works well when success rate differences ae substantial and the number of rollouts is sufficient.

With SP approach, the optimization component 300 creates a continuous value between 0 and 1 based on the magnitude of difference between success rates. The formula for this approach is as follows:

$${α}_{k} = σ ( ( {p}_{sk} - {p}_{{s}^{′} k} ) / μ ) \qquad Equation 5$$

where, αₖ is a preference value (between 0 and 1) for step k; σ( ) is sigmoid function, which transforms any real number into a value between 0 and 1; pₛₖ is the success rate of the original step Sₖ; p_{s′k} is the success rate of the alternative step S′ₖ; − is a subtraction operator finding the difference between success rates; μ is a calibration parameter that controls how sharply the preference changes; and/is a divisional operator.

In Equation 5, σ represents the sigmoid function and p is a calibration parameter that controls how sharply the preference changes with success rate differences. The SP approach is particularly applicable when working with limited rollout samples where estimation uncertainty is higher.

After preference values (αₖ) between steps based on these success rates has been established, the optimization component 300 feeds the preference values into the Bradley-Terry (BT) model to formalize the probability that one step is better than another:

$$p ( {s}_{k} ≻ {s}_{k}^{′} ) = σ ( r ( {s}_{k} ) - r ( {s}_{k}^{′} ) ) \qquad Equation 6$$

Where: p(Sₖ>S′ₖ) is the probability that step Skis preferred over step S′ₖ; = is equality operator; σ( ) is sigmoid function that converts any real number to a value between 0 and 1; r(Sₖ) is the reward function value for step Sₖ; r(S′ₖ) is the reward function value for step S′ₖ; and − is the subtraction operator calculating the difference between rewards.

Finally, the optimization component 300 updates the CoTR ML model 130 to the preferences of the steps of the step set using a direct preference optimization (DPO) loss function. This update transforms empirical preferences into parameter updates of the CoTR ML model 130 that improve the reasoning capabilities of the model.

The update of the CoTR ML model 130 with the preferences includes several interconnected steps. First, the optimization component 300 calculates reward scores for the steps of the step set using the reward function r(Sₖ)=β log(π_θ(Sₖ|s<k,H^{AV})/π_ref(Sₖ|s<k,H^{AV}))+β log Z, which compares the current policy to a reference policy for generating each step.

The current policy (π_{θ}) and reference policy (π_{ref}) are components in the reward calculation of the optimization. The current policy represents the CoTR ML model 130 with its present parameters being optimized, specifically the probability distribution it assigns to generating particular reasoning steps given previous context and multimodal inputs. The reference policy serves as a baseline-typically the state of the CoTR ML model 130 after supervised fine-tuning but before preference optimization, or a frozen earlier checkpoint that anchors the optimization process. In the reward function, these policies are compared through their ratio, measuring how much the reasoning of the current CoTR ML model 130 differs from the baseline. This approach enables the CoTR ML model 130 to learn from preferences without explicit reward prediction, while the parameter 3 controls acceptable deviation, preventing dramatic changes while still allowing preference-based improvements.

Next, the optimization component 300 defines preference probabilities between each step of the step set using the BT model (see Equation 6). These probabilities represent the current prediction by the model of which step is better.

Following this, the optimization component 300 creates preference labels based on the success rates of the steps of the step set, using either hard values (with the BBP approach) or soft values (with the SP approach) to accommodate estimation uncertainty.

The optimization component 300 then computes preference mismatch penalties for comparisons between each step of the step set. The preference mismatch penalties measure how well the current predictions of the CoTR ML model 130 align with the empirical preferences derived from success rates.

One or more implementations compute two preference mismatch penalties. Each preference mismatch penalty is a specific mathematical term calculated for a particular step comparison:
Better-step Underestimation Penalty [αₖ log p(Sₖ>S′ₖ)]: Increases when the CoTR ML model 130 assigns insufficient probability to step Sₖ that empirically performs better according to success rates. The penalty grows larger when αₖ is high, but p(Sₖ>S′ₖ) is low; and
Worse-step Overestimation Penalty [(1−αₖ) log p(S′ₖ>Sₖ)]: Increases when the CoTR ML model 130 assigns excessive probability to step S′ₖ that empirically performs worse according to success rates. The penalty grows larger when (1−αₖ) is low but p(S′ₖ>Sₖ) is high.

The magnitude of these penalties directly reflects the severity of misalignment. For example, when αₖ=1 (e.g., strongly preferring step Sₖ based on success rates), but the model predicts p(Sₖ>S′ₖ)=0.2 (e.g., weakly preferring S′ₖ), this creates a large penalty through the negative logarithm. Conversely, when the preferences of the CoTR ML model 130 closely match empirical preferences, these penalties become minimal.

These fine-grained penalties allow the optimization component 300 to precisely identify which step comparisons show the greatest mismatch between empirical evidence and model behavior, targeting parameter updates to where they are most needed. The penalties account for both preference direction (e.g., which step is better) and preference magnitude (e.g., how much better), creating a nuanced training signal that reflects the full spectrum of empirical performance differences observed during rollouts.

The optimization component 300 calculates these specific penalty terms for every pairwise comparison between steps in the step set. Each comparison generates its own penalty values based on how well the predicted preferences align with the empirical preferences derived from success rates.

The optimization component 300 combines the preference mismatch penalties into a loss function, such as the DPO loss function. The optimization component 300 combines all individual preference mismatch penalties into a single comprehensive mathematical value. Specifically, the DPO loss function takes the average of all Better-step Underestimation Penalties and Worse-step Overestimation Penalties calculated for every step comparison in the training data.

The DPO loss function applies this averaging across all reasoning sequences, all positions within those sequences, and all question-answer pairs being processed. This aggregation converts potentially thousands of individual penalty calculations into a single scalar value that the optimization component 300 can minimize through parameter updates to the CoTR ML model 130. The resulting comprehensive loss value provides a unified optimization objective that guides gradient descent, improving model performance across all reasoning steps simultaneously.

The DPO loss function is:

$$ℒ = - 𝔼 [ {α}_{k} log p ( {s}_{k} ≻ {s}_{k}^{′} ) + ( 1 - {α}_{k} ) log p ( {s}_{k}^{′} ≻ {s}_{k} ) ] \qquad Equation 7$$

where: [symbol] is the total loss value to be minimized during optimization; −E[ . . . ] is the negative expected value across all preference pairs; negative to maximizing alignment with preferences; Two complementary terms (the function balances two objectives based on preference strength); First Term: better-step underestimation penalty; Second Term: Worse-step Overestimation Penalty; Predicted Probabilities: p(Sₖ>S′ₖ) is calculated using BT model; r(Sₖ) is reward function comparing current policy to reference policy for generating step Sₖ; Optimization Effect: when αₖ=1, the loss is minimized when model strongly prefers Sₖ; when αₖ=0, the loss is minimized when model strongly prefers S′ₖ; when αₖ is between 0-1, the preference strength of the model should match the empirical preference strength.

The optimization component 300 calculates gradients of the DPO loss function with respect to parameters of the CoTR ML model 130. These gradients quantify how parameter changes would affect the overall loss value. In some implementations, the calculation may focus on specific parameter subsets, primarily the LoRA parameters with hyperparameters r=64 and α=256. The gradient vector provides both direction and magnitude for optimal parameter adjustments.

After gradient calculation, the optimization component 300 updates the parameters of the CoTR ML model 130 using gradient descent to align with the preferences of the steps of the step set. The optimization component 300 applies updates using gradient descent techniques. Each parameter receives an update proportional to the corresponding gradient value. Updates are typically scaled by a learning rate hyperparameter. In some implementations, a mathematical goal is minimization of preference mismatch penalties across all step comparisons.

These updates modify internal representations and output distributions of the CoTR ML model 130. Parameters gradually shift to increase probabilities of generating effective reasoning steps. Batch processing allows efficient update calculation across multiple examples simultaneously. The optimization component 300 may repeat this optimization many times with different training examples. Subsequent iterations further refine the parameters toward better reasoning capabilities. The cumulative effect transforms the CoTR ML model 130 into a system that generates more effective reasoning approaches.

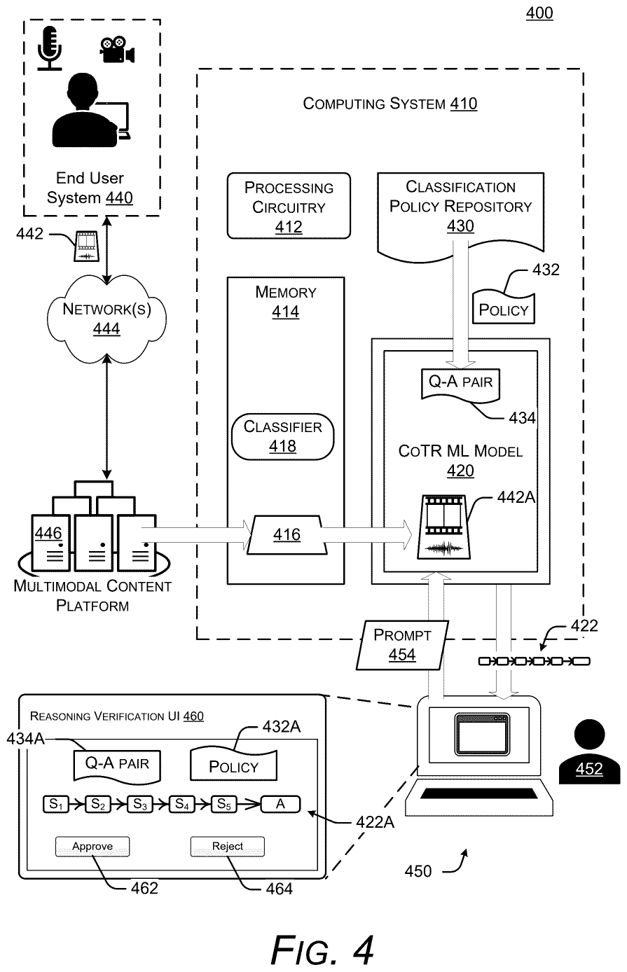

FIG. 4 illustrates a schematic view of an operating environment 400 of a computing system 400 with a CoTR ML model 420 that has been fine-tuned in accordance with an example of the optimization described in the present disclosure. FIG. 4 primarily depicts practical uses for an already fine-tuned ML model.

The operating environment 400 includes a workstation 450 and the computing system 410, which has a processing circuitry 412, memory 414, the CoTR ML model 420, and a classification policy repository 430. Within the operating environment 400, the ML model 420 has already been “fine-tuned” using an implementation of reasoning-enhanced direct-preference optimization, as described herein.

The memory 114 stores multimodal content 416, which may be acquired, as depicted, from a multimodal content platform 446, which is external to the computing system 410. Multimodal content platform 446 may serve as digital ecosystems where users create, share, and consume diverse media formats including videos, images, and audio. The platform may thrive on user-generated content while employing sophisticated algorithms that personalize feeds based on individual preferences.

The computing system 410 may access the multimodal content platform 446 via connections through wireless networks (e.g., WiFi™, cellular data) or wired connections (e.g., ethernet). Additionally, the computing system 410 and the multimodal content platform 446 may be connected to a public communications network 444, which may be commonly called the Internet or “the cloud.”

In addition, an end user system 440 may be connected to the multimodal content platform 446 via the network 444. Using the platform, a user of the end user system 440 may use the built-in creation tools of the platform for users to produce content directly within the platforms, often enhanced by filters and effects. To that end, the end user may employ the depicted microphone and video camera to create user-generated multimodal content 442 (which includes visual information with its corresponding audio information).

The user-generated multimodal content 442 may be uploaded to the multimodal content platform 446 via the network 444. The user-generated multimodal content 442 finds its way to be stored amongst the multimodal content 416 in the memory 414 of the computing system 410. Thus, the memory 414 may store a copy 442A of the user-generated multimodal content (which may have audio and video information) as part of the multimodal content 416. As depicted, the copy 442A of the user-generated multimodal content is extracted from the multimodal content 416 in the memory 414 and supplied to the CoTR ML model 420 as input. This copy 442A includes both visual information (e.g., visual frames of a video) along with corresponding audio information.

The classification policy repository 430 includes one or more datasets of rules and guidelines—called a policy 432—related to how multimodal content (e.g., copy 442A) should be classified (e.g., categorized or organized). Typically, a policy includes, at least partially, human-curated rules and guidelines. A policy may include a structured or unstructured dataset of text-based rules or guidelines that may be used to categorize content items (e.g., data). There are various applications for such policies. Examples of such applications include content moderation, data governance and security (e.g., public, confidential, restricted access), records management (e.g., document retention and regulatory requirements), and storage management (e.g., segregating where and how data is stored based on type, age, and usage).

Content management may be a purpose of the policy 432 of the classification policy repository 430. Content management is the moderation and organization of user-generated content for the multimodal content platform 446 that makes sure that the user-submitted content meets a standard as defined by a content-management policy. That standard may involve avoiding inappropriate or offensive content, minimum video quality, effective labeling to aid retrieval, and the like.

To accomplish this, policies are created to provide guidelines on how to classify content items into classes that are handled differently. For example, suppose that a social media platform specialized in cat videos. A policy for this platform may specify that any video without a cat is excluded and not publicly posted to their platform. Thus, enforcement of that policy would identify any non-cat videos. Thus, such videos are classified as non-cat. Such videos are then excluded from the platform.

In some instances, a Q-A pair 434 may be selected from a classification policy of the classification policy repository 430 to facilitate classifying the multimodal content (e.g., copy 442A). In other instances, the classification policy repository 430 may supply the Q-A pair 434 to the CoTR ML model 420 to further the content management or other policy-based operation.

While shown separate from the memory 114, the CoTR ML model 420 and the classification policy repository 430 may be implemented as stored data and/or instructions in the memory 414 that, when executed, that, when executed, cause the processing circuitry 412 execution the functions of the CoTR ML model 420 and the classification policy repository 430.

The memory 414 also stores a classifier 418, which is a program module that stores instructions that, when executed, cause the processing circuitry 412 to classify (e.g., analyze and categorize) multimodal content by utilizing the already fine-tuned CoTR ML model 420. The classifier 418 may process video clip copy 442A and assign it to predefined categories based on specific classification criteria.

The classifier 418 may employ classification standards from policy 432 acquired from the classification policy repository 430. These policies might include content quality requirements, platform guidelines, or detection parameters for synthetic media. When activated, the classifier 418 may formulate appropriate question-answer prompts that frame the policy evaluation task for the CoTR ML model 420.

Unlike traditional black-box approaches, the classifier 418 utilizes the step-by-step reasoning capabilities of the CoTR ML model 420. This provides transparent classification decisions with supporting rationales. The classifier 418 converts video clip copy 442A into model-compatible inputs, applies the relevant policy 432 parameters as questions, and interprets both the reasoning steps and final determination produced by the CoTR ML model 420. The resulting classification includes both the category assignment and the supporting reasoning chain that led to that conclusion. These reasoning chains facilitate human review of automated decisions, when necessary, particularly for borderline cases or policy appeals.

In addition to classifying, the memory 414 may also store other specialized program modules similar to classifier 418. These specialized program modules (not specifically shown) contain instructions that, when executed, cause the processing circuitry 412 to detect and/or understand the multimodal content by utilizing the already fine-tuned CoTR ML model 420. Detection functionality differs from classification by focusing on identifying specific elements, patterns, anomalies, or objects within multimodal content (e.g., video clip copy 442A) rather than assigning the entire content to predefined categories. Detection modules might locate temporal events (e.g., scene changes), recognize particular objects or people, identify specific audio elements, or pinpoint synthetic artifacts within generated content.

Understanding modules, while similar in implementation to classifier 418, focus on extracting meaningful relationships, context, narratives, or causal connections from the multimodal content (e.g., video clip copy 442A). These modules prompt the CoTR ML model 420 to generate interpretations of content meaning rather than categorical assignments. Understanding might involve, for example, summarizing key story elements, explaining speaker intentions in a presentation, identifying emotional tones in conversations, or determining the purpose of specific visual-audio combinations. Like the classifier 418, these modules leverage the step-by-step reasoning capabilities of the CoTR ML model 420 to provide transparent explanations of their interpretations.

Both detection and understanding modules transform their respective analytical processes into question-answer formats suitable for the CoTR ML model 420. They may access the same policy repository 430 to acquire parameters that guide their analysis, though with different emphasis than classification tasks. For example, a detection module might reference policies about what constitutes synthetic content artifacts, while an understanding module might reference contextual guidelines for interpreting educational content. The outputs from these modules typically include both the detected elements and derived understanding along with the supporting reasoning chains that demonstrate how the CoTR ML model 420 arrived at its conclusions.

Indeed, since the CoTR ML 420 model is already fine-tuned in accordance with the optimization approach described herein, the sequence of steps supplied by the model are based on the preferences determined by that approach. Thus, when the CoTR ML model is employed to generate a sequence 422 of steps in order to classify, detect, and/or understand the multimodal content (e.g., copy 442A), that sequence of steps is based on the preferences built into the fine-tuned model.

The workstation 450 serves as an interface point where a user 452 can interact with the underlying CoTR ML model 420 through a structured workflow. This workstation 450 may exist as a desktop computer, laptop, tablet, or specialized terminal, connected either directly or through secure network protocols.

A user-interface (UI) named reasoning verification 460 is shown and it is indicated that this is displayed on the display screen of the workstation 450. When displayed, the reasoning-verification UI 460 may include a Q-A pair 434A (which may be a version of Q-A pair 434), policy 432A (which may be a version of policy 432), and a reasoning sequence 422A (which may be a version of sequence 422).

The reasoning-verification UI 460 provides a human oversight mechanism for the decision-making process of the CoTR ML model 420. When the CoTR ML model 420 performs an analytical function, it generates sequence 422 containing the step-by-step reasoning employed to reach its conclusion about the multimodal content. This detailed sequence arrives at the workstation 450 and appears as element 422A within the reasoning-verification UI 460, displayed in a structured format that delineates each reasoning step.

The UI may present these steps chronologically, highlighting key insights, multimodal observations, and logical connections made by the model. Also, the reasoning-verification UI 460 incorporates interactive elements such as approval button 462, rejection button 464, or other step-specific feedback mechanisms. These input controls enable the user 452 to evaluate the quality and correctness of the reasoning process of the model, either endorsing sound analytical paths or flagging problematic steps for further review.

When rejection occurs, the system may collect specific feedback about which reasoning steps contained errors, enabling targeted improvement of the CoTR ML model 420 through additional fine-tuning. This human-in-the-loop verification process ensures accountability in automated decision systems while providing valuable training signals for continued model enhancement.

With the workstation 450, the user 452 may interact with the CoTR ML model 420 by sending it a prompt 454 based on identified multimodal content. Typically, the prompt 454 contains a specific question, instruction, or analytical request regarding the multimodal content, such as video clip copy 442A. These prompts might include requests to explain events in the video, identify policy violations, detect synthetic elements, or understand relationships between audio and visual components.

Upon submission, the prompt 454 triggers the CoTR ML model 420 to perform an inference on multimodal content in response to receiving the prompt 454. With the inference, the CoTR ML model 420 may process both the multimodal content and the prompt together, generating a reasoning sequence 422 that connects the question to an answer. The resulting inference output includes both the final answer and the step-by-step reasoning chain, enabling the user 452 to understand not just what conclusion the model reached, but how it arrived there. This transparency allows the user 452 to evaluate the reasoning of the model, accept or reject its conclusions, and formulate follow-up prompts for deeper analysis or clarification of specific reasoning steps.

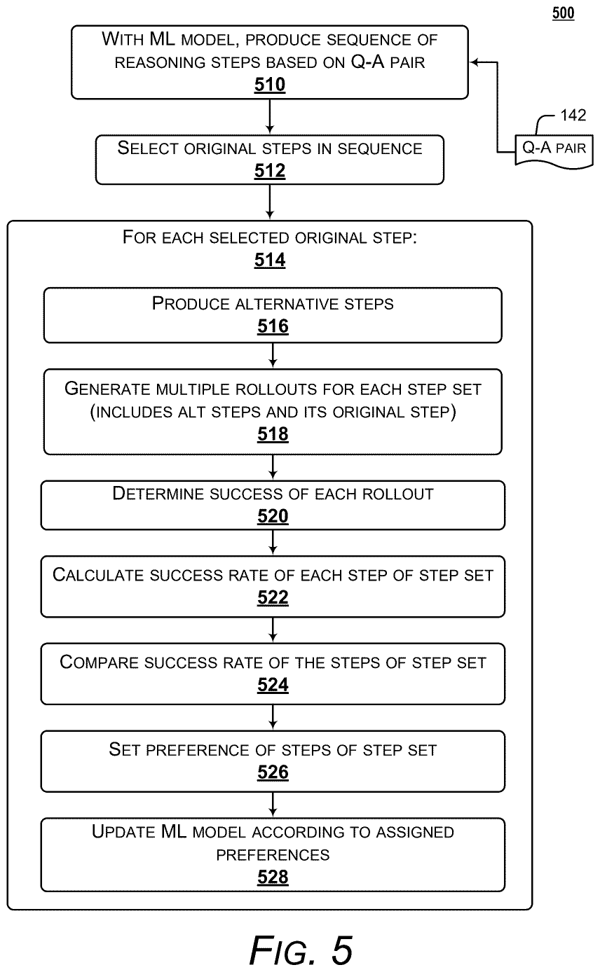

FIG. 5 is a flow chart of an example method 500 for reasoning-sequence direct-preference optimization according to an example embodiment of the present disclosure. For simplicity, the example method 500 is described as being performed by a “system,” which includes the computing system 100 or 400 described above or a computer system 900 described below.

At 510, using a pre-trained multimodal reasoning-enhanced machine-learned (ML) model (e.g., CoTR ML model 130), the system produces a sequence of reasoning steps based on a question-answer pair (e.g., Q-A pair 142) about multimodal content that connects the question to the answer. As used herein, “reasoning-sequence” is synonymous with sequence of reasoning steps. The multimodal content includes audio information and visual information, and the question-answer pair concerns aspects found in the audio information, visual information, or a combination thereof.

The multimodal content typically consists of videos with synchronized audio tracks, where visual elements may include objects, people, scenes, actions, or text while audio elements may include speech, music, sound effects, or ambient noise. The question-answer pair may target specific temporal segments, cross-modal relationships, causal connections, or contextual understanding that require integrating both visual and auditory information streams.

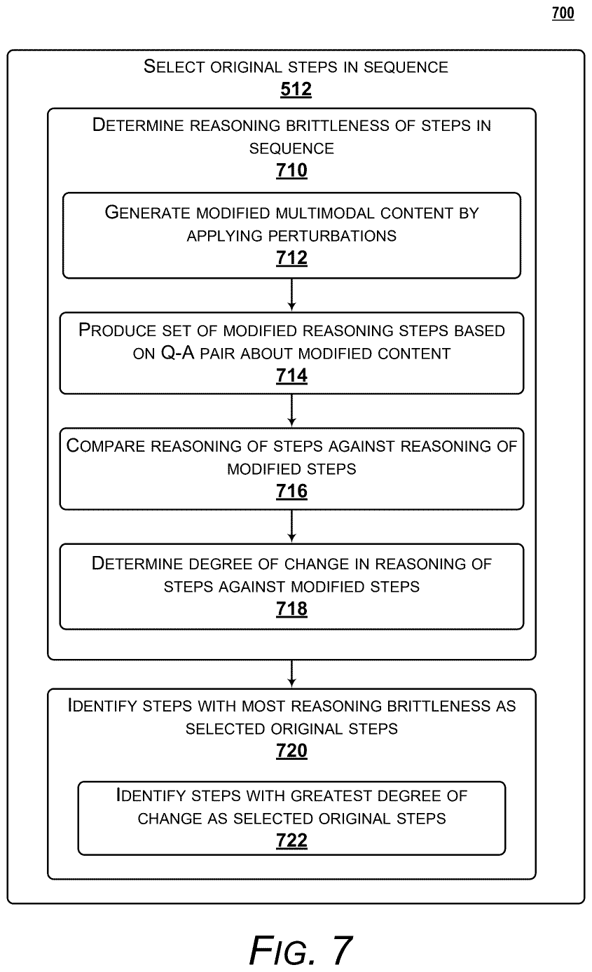

At 512, the system selects one or more original steps in the sequence of reasoning steps. Each selected one or more original steps has a defined position in the sequence. The selection of original steps may utilize contrastive step selection, which is shown in FIG. 7 and discussed in its accompanying description. The contrastive step selection identifies steps most susceptible to input perturbations through KL-divergence measurements. A defined position in the sequence means the step occupies a specific location in the reasoning chain, such as being the second or third step in a sequence leading from question to answer.

At 514, the system loops or repeats the following operations (516-528) for each selected original step. The looping structure ensures systematic processing of each selected step independently before moving to the next selected step in the sequence. This loop-based approach may allow for parallel processing of multiple steps while maintaining proper sequence integrity and computational efficiency.

At 516, the system, based on question-answer pair (e.g., Q-A pair 142), produces one or more alternative steps that have a defined position in the sequence corresponding to an original step. The one or more alternative steps and the corresponding original step form a step set. Alternative steps represent different potential reasoning approaches at the same sequence position, generated through controlled sampling parameters that maintain logical coherence with preceding steps. The step set concept creates a collection of competing reasoning formulations at identical sequence positions for comparative evaluation through the subsequent rollout process.

At 518, the system generates multiple rollouts for each step of the step set. Multiple rollouts involve continuing the reasoning sequence from each step in the step set to completion. This may generate, for example, 6-10 different reasoning continuations per step. These rollouts provide statistical sampling of possible reasoning trajectories, allowing empirical measurement of the likelihood of each step leading to correct answers.

At 520, the system determines success of each rollout. Success determination involves comparing the final answer from each rollout against the reference answer from the question-answer pair. This may involve a binary evaluation, which marks each rollout as either successful (1) or unsuccessful (0) based on whether the generated answer matches the reference answer.

At 522, the system calculates a success rate of each step of the step set. Success rate calculation divides the number of successful rollouts by the total number of rollouts for each step in the step set. This calculation produces a probability estimate between 0 and 1 that represents how likely each reasoning approach is to lead to a correct answer.

At 524, the system compares the calculated success rate of the steps of the step set. The comparison process involves direct mathematical contrasting of success rates between steps occupying the same position in the sequence. This comparison establishes which reasoning approaches at that position most reliably lead to correct answers and by what margin.

At 526, the system assigns preferences relative to the steps of the step set based on the comparison of the calculated success rate thereof. The preference assignment includes selection of a most successful step from amongst the steps of the step set and adjustment the highest preference to include the most successful step. Preference assignment creates either binary values (using indicator functions) or continuous values (using sigmoid normalization) that reflect the relative performance of each step. The most successful step receives the highest preference value, creating a training signal that will increase the probability of generating similar reasoning in future iterations.

At 528, the system updates the ML model (e.g., CoTR ML model 130) to the preferences of the steps of the step set. Model updating applies gradient-based optimization techniques that adjust model parameters in accordance with the Direct Preference Optimization loss function. The update process specifically targets key parameters while preserving the general capabilities of the model, incrementally improving reasoning quality across multiple training iterations.

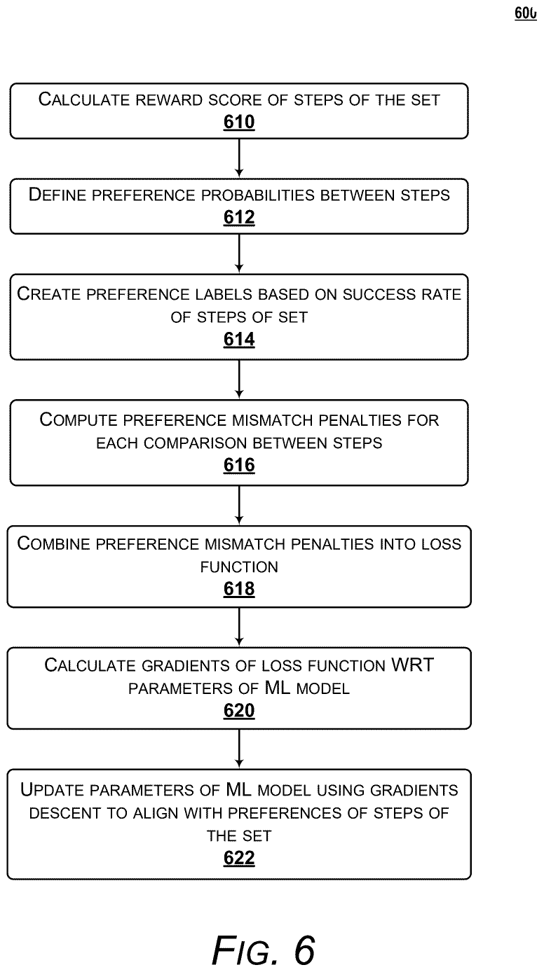

FIG. 6 is a flow chart of an example method 600 for updating the machine-learned model according to an example embodiment of the present disclosure. The example method 600 performs the update of the ML model with the assigned preferences, which is operation 528 of method 500. For simplicity, the example method 600 is described as being performed by a “system,” which includes the computing system 100 or 400 described above or a computer system 900 described below.

At 610, the system calculates reward scores for the steps of the step set. The reward scores are calculated using a function that compares the ratio between current policy and reference policy probabilities for generating each step in the step set. These scores utilize the reward function r(Sₖ)=β log(π_θ(Sk|s<k,H^{AV})/π_ref(Sk|s<k,H^{AV}))+β log Z, which compares the current pol icy to a reference policy for generating each step.

At 612, the system defines preference probabilities between each step of the step set. Preference probabilities are defined using the BT model (see Equation 6), which converts reward differences into probabilities through a sigmoid function. The formula p(Sₖ>S′ₖ)=σ(r(Sₖ)−r(S′ₖ)) represents the model-predicted probability that one step is better than another based on current parameter values.

At 614, the system creates preference labels based on the success rates of the steps of the step set. Preference labels can be created using either hard binary assignment (see BBP approach) or soft continuous assignment (see SP approach). These labels represent the ground truth preferences derived from empirical success rates, with hard labels providing clear training signals and soft labels accounting for estimation uncertainty.

At 616, the system computes preference mismatch penalties for comparisons between each step of the step set. Preference mismatch penalties include the better-step underestimation penalty and the worse-step overestimation penalty. Each penalty term quantifies a specific type of misalignment between empirical preferences and model predictions for a particular step comparison.

At 618, the system combines the preference mismatch penalties into a loss function. The DPO loss function (see Equation 7) combines all individual penalties through expectation (e.g., averaging). This unified loss value provides a single optimization objective that accounts for all preference relationships across the entire dataset.

At 620, the system calculates gradients of the loss function with respect to parameters of the ML model. Gradients are calculated through partial derivatives of the loss function with respect to each trainable parameter in the ML model. These partial derivatives quantify how small changes in each parameter would affect the overall loss value, indicating both direction and magnitude for optimal parameter adjustments.

At 622, the system updates the parameters of the ML model using gradient descent to align with the preferences of the steps of the step set. Gradient descent updates apply parameter changes proportionally to the calculated gradients. Each update incrementally shifts the ML model parameters to increase probabilities of generating reasoning steps that historically led to correct answers, gradually improving reasoning capabilities across multiple iterations.

FIG. 7 shows a flowchart of an example method 700 performing contrastive step selection according to an example embodiment of the present disclosure. The example method 600 performs the selection of the one or more original steps, which is operation 512 of method 500. More particularly, method 700 performs contrastive step selection. For simplicity, the example method 700 is described as being performed by a “system,” which includes the computing system 100 or 400 described above or a computer system 900 described below.

The method 700 is contained in operation 512 of method 500. In that operation, the system selects one or more original steps in the sequence of reasoning steps. The selection of original steps may utilize contrastive step selection. Indeed, that is what is shown in method 700 described hereafter.

At 710, the system determines reasoning brittleness of the steps of the sequence, wherein the reasoning brittleness of a step indicates a sensitivity of the step to changes in reasoning relative to changes in the multimodal content. Operation 710 contains operations 712-718, which are described below.

Reasoning brittleness quantifies how unstable a reasoning step becomes when slight modifications are made to the input multimodal content. High brittleness indicates steps where small input perturbations cause disproportionately large changes in reasoning outcomes, often identifying points where the ML model lacks robust understanding or relies on unstable feature detection.

At 720, the system labels one or more of the original steps as having most reasoning brittleness as the selected one or more original steps. Operation 710 contains operation 722, which is described below.

Selecting steps with the most reasoning brittleness focuses computational resources on optimizing the most vulnerable parts of the reasoning chain. These brittle steps typically represent junctures where reasoning errors frequently occur, making them high-leverage points for improvement through the subsequent optimization process.

At 712, the system generates modified multimodal content by applying perturbations to the multimodal content. Perturbations may include, for example, subtle modifications to pixel values, minor frame alterations, slight audio adjustments, or small temporal shifts that preserve semantic content. These carefully calibrated changes are designed to be imperceptible to humans while potentially revealing instabilities in the ML model reasoning process.

At 714, the system, using the ML model, produce a set of modified reasoning steps based on the question-answer pair about modified multimodal content, wherein each modified step has a corresponding step in the sequence. Modified reasoning steps represent how the ML model reasons differently when given the perturbed multimodal content compared to the original content. Each modified step directly corresponds to a specific step in the original reasoning sequence, allowing precise comparison of reasoning changes at each position in the sequence.

At 716, the system compares the reasoning of the steps against the reasoning of the modified steps. The comparison examines differences in logical structure, entity recognition, relationship identification, and conclusion formation between original and modified reasoning. This analysis reveals which aspects of reasoning remain stable across perturbations versus which aspects change dramatically with minimal input modification.

At 718, the system determines a degree of change in reasoning of the steps against the modified steps. The degree of change may be determined by computing a KL-divergence of reasoning results between the modified step and a corresponding step in the sequence.

KL-divergence measures the statistical difference between probability distributions of tokens generated at each reasoning step under original versus perturbed inputs. This information-theoretic measure quantifies precisely how much the reasoning distribution changes at each step, with higher values indicating greater instability in response to input perturbations.

At 722 (which is part of operations 720), the system labels one or more of the original steps with the greatest degree of change as the selected one or more original steps. Steps exhibiting the greatest KL-divergence values are prioritized for subsequent optimization through the direct-preference optimization described herein. These high-divergence steps represent reasoning vulnerabilities where improving robustness will yield the largest gains in overall model performance with minimal computational expense.

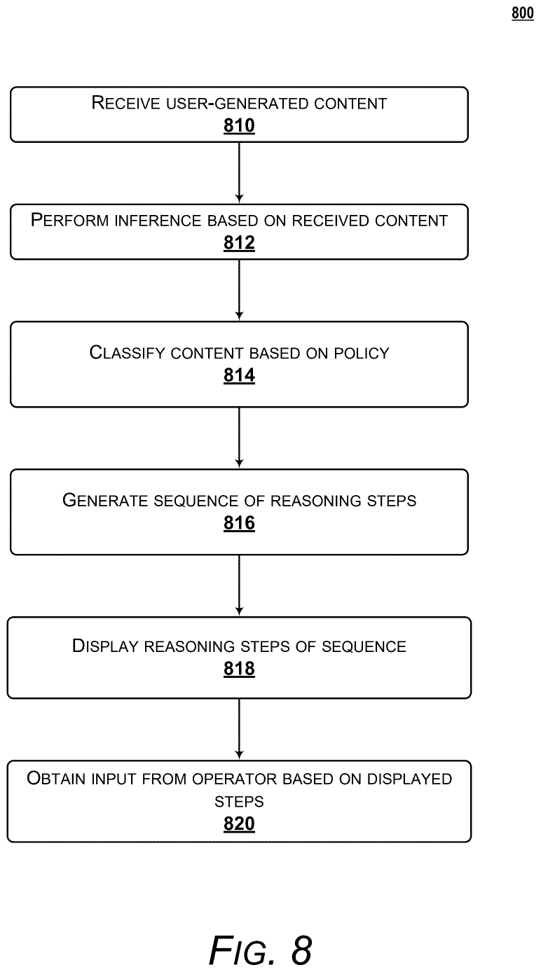

FIG. 8 shows a flowchart of an example method 800 performing inference using an updated machine-learned model according to an example embodiment of the present disclosure. For simplicity, the example method 800 is described as being performed by a “system,” which includes the computing system 100 or 400 described above or a computer system 900 described below.

At 810, the system receives user-generated multimodal content. The user-generated multimodal content may include videos with synchronized audio that may contain various visual elements such as people, objects, scenes, actions, and text alongside audio components like speech, music, and sound effects. The system receives this content through upload interfaces, streaming APIs, or database connections that handle the transfer and initial processing of potentially large multimedia files.

At 812, the system performs inference based on the user-generated multimodal content in response to a received prompt. Inference involves the ML model applying learned parameters to analyze new content and generate outputs based on both the content and specific instructions contained in the prompt. The prompt might include specific questions about content elements, requests for classification according to policies, or instructions to analyze particular aspects of the audio-visual relationship within the content.

At 814, the system classifies the user-generated multimodal content based on a classification policy and/or a Q-A pair. In addition, the system may detect and/or understand the user-generated multimodal content. Classification assigns the content to predefined categories based on criteria outlined in the classification policy, such as content rating, compliance with platform guidelines, or content type designations. Detection and understanding functions differ from classification by identifying specific elements within content (e.g., detection) or extracting meaningful relationships and context (e.g., understanding) rather than assigning whole-content categorical labels.

At 816, the system generates sequence of reasoning steps perhaps in response to the prompt, classification, detection, and/or understanding. The system may generate the sequences of steps employed to classify, detect, and/or understand the multimodal content, and the sequence of steps are based on the preferences of the steps of the step set.

The reasoning sequence represents a logical chain of observations, inferences, and conclusions that connect the initial content analysis to the final determination. These sequences reflect the optimized reasoning patterns learned during training through the directed-preference optimization described herein, incorporating the preferences for step approaches that historically led to correct answers across similar content types.

At 818, the system displays the reasoning steps of the sequence. The display of reasoning steps typically occurs within a specialized interface that presents each step chronologically with clear delineation between observations, inferences, and conclusions. Visual organization elements such as numbered sequences, indentation, highlighting of key points, or even graphical representations may enhance comprehension of the reasoning flow for human operators.

At 820, the system obtains input from the operator based on the displayed steps on a user interface (UI). The UI may display the employed sequences of steps to classify, detect, and/or understand the multimodal content and display an input mechanism for receiving input accepting or rejecting the employed sequence. The input may be acceptance, or a rejection based upon whether the reasoning logically lands at correct answer based on a Q-A pair and/or a policy. Indeed, the Q-A pair may be selected form a classification policy to facilitate classifying the multimedia content.

The UI typically includes interactive elements such as approval buttons, rejection indicators, dropdown menus for feedback categories, or free-text fields for step-specific comments. Human evaluation criteria focus on logical coherence, factual accuracy, policy alignment, and sound reasoning principles rather than subjective preferences, ensuring feedback addresses genuine reasoning flaws rather than stylistic differences.

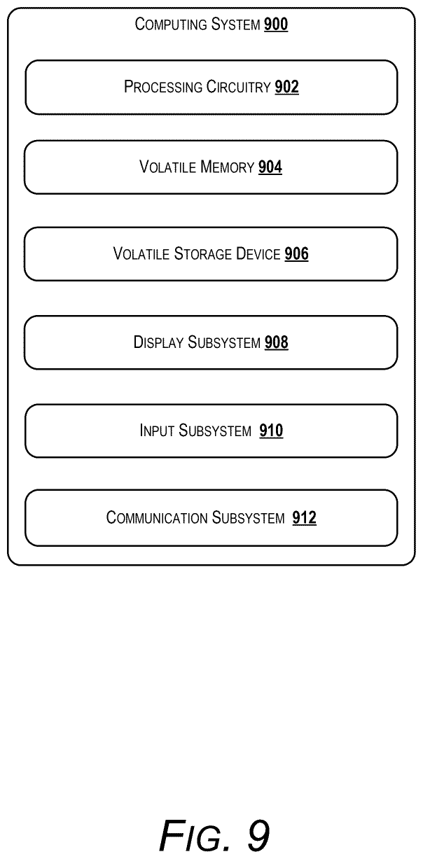

FIG. 9 schematically shows a non-limiting embodiment of a computing system 900 that can enact one or more of the methods and processes described above. Computing system 900 is shown in simplified form. Computing system 900 may embody the computing system 100 described above and illustrated in FIG. 1 and/or computing system 400 described above and illustrated in FIG. 4.

Components of computing system 900 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 900 includes a processing circuitry 902 volatile memory 904, and a non-volatile storage device 906. Computing system 900 may optionally include a display subsystem 908, input subsystem 910, communication subsystem 912, and/or other components not shown in FIG. 9.

Processing circuitry 902 includes one or more physical devices configured to execute instructions. For example, the processing circuitry may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry may include one or more physical processors configured to execute software instructions. Additionally or alternatively, the processing circuitry may include one or more hardware logic circuits or firmware devices configured to execute hardware-implemented logic or firmware instructions. Processors of the processing circuitry 902 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. Aspects of the processing circuitry may be virtualized and executed by remotely accessible, networked computing devices configured in a cloud-computing configuration. In such a case, these virtualized aspects are run on different physical processing circuitry of various different machines, it will be understood.

Non-volatile storage device 906 includes one or more physical devices configured to hold instructions executable by the processing circuitry to implement the methods and processes described herein. When such methods and processes are implemented, the state of non-volatile storage device 906 may be transformed—e.g., to hold different data.

Non-volatile storage device 906 may include physical devices that are removable and/or built in. Non-volatile storage device 906 may include optical memory, semiconductor memory, and/or magnetic memory, or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by processing circuitry 902 to temporarily store information during processing of software instructions. It will be appreciated that volatile memory 904 typically does not continue to store instructions when power is cut to the volatile memory 904.

Aspects of processing circuitry 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via processing circuitry 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 908 may be used to present a visual representation of data held by non-volatile storage device 906. The visual representation may take the form of a graphical user interface (GUI). As the herein described methods and processes change the data held by the non-volatile storage device and thus transform the state of the non-volatile storage device, the state of display subsystem 908 may likewise be transformed to visually represent changes in the underlying data. Display subsystem 908 may include one or more display devices utilizing any type of technology. Such display devices may be combined with processing circuitry 902, volatile memory 904, and/or non-volatile storage device 906 in a shared enclosure, or such display devices may be peripheral display devices.

When included input subsystem 910 may comprise or interface with one or more user-input devices such as a keyboard, mouse, touch screen, camera, or microphone.

When included communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 900 to send and/or receive messages to and/or from other devices via a network such as the Internet.

A baseline performance comparison of the reasoning-sequence direct-preference optimization for multimodal ML model (RSDPOM) was done. The results are reproduced in Table 1 below. However, the names of the known benchmark tests, testing datasets, commercially available models, and open-source models have been withheld. Table 1 below establishes baseline performance across multiple benchmarks.

TABLE 1
Modality AVBench

| | | | | Bencher | | |
|---|---|---|---|---|---|---|
| Model | Modality | AVBench | CasualTst | Funny | School | Faker |

Category A Models

| | | | | | | |
|---|---|---|---|---|---|---|
| ProVision | A + V | 75.0%† | 79.2% | 75.8% | 67.1% | 23.6% |
| | | | | | | (55%/15%) |
| ProVision + | A + V | 75.1% | 79.5% | 81.8% | 69.5% | 40.0% |
| reasoning | | | | | | (49%/34%) |
| OmniChat | V | 71.9%† | 81.7% | 63.3% | 60.0% | 34.1% |
| | | | | | | (90%/21%) |
| OmniChat + | V | 72.1% | 81.9% | 69.6% | 61.0% | 25.8% |
| reasoning | | | | | | (53%/17%) |

Category B Models

| | | | | | | |
|---|---|---|---|---|---|---|
| VisionNU | V | 58.2%† | 79.4%† | 67.2% | 45.8% | 0.0% |
| | | | | | | (97%/0%) |
| RSDPOM | A + V | 43.3% | 49.2% | 47.8% | 33.6% | 0.0% |
| | | | | | | (100%/0%) |
| VideoLM | A + V | 54.9%† | 75.6% | 53.7% | 34.3% | 0.0% |
| | | | | | | (99%/0%) |
| RSDPOM | A + V | 62.9% | 78.2% | 68.6% | 42.5% | 5.8% |
| (SFT) | | | | | | (97%/5%) |
| RSDPOM | A + V | 65.6% | 82.3% | 76.7% | 48.3% | 17.8% |
| (pDPO) | | | | | | (87%/13%) |

AV Bench, an audio-visual understanding test, evaluates comprehension of synchronized audio and video content. CausalTst, a temporal reasoning evaluation, focuses on understanding actions and consequences in video. Bencher, a reasoning-intensive video benchmark, contains several specialized test categories. Funny, a comedy comprehension dataset within Bencher, tests understanding of humor in video performances. School, an educational content dataset in Bencher, evaluates comprehension of instructional presentations. Faker, a synthetic content detection test reporting precision/recall metrics, identifies artificial-intelligence (AI)-generated videos.

The RSDPOM is the label used in these table to represent a multimodal ML model optimized using the technology described herein. In particular, the RSDPOM (pDPO) represents a fully optimized system, which achieves 65.6% on AV Bench, 82.3% on CausalTst, 76.7% on Funny, and 48.3% on School. Furthermore, on Faker, the system achieves 17.8% F1-score with 87% precision and 13% recall. These results surpass VisionNU, a visual-only baseline model (58.2%, 79.4%, 67.2%, 45.8%), as well as VideoLM, an audio-visual foundation model (54.9%, 75.6%, 53.7%, 34.3%). Despite parameter count differences, the system demonstrates competitive performance against Category A models ProVision (75.0%, 79.2%, 75.8%, 67.1%) and OmniChat (71.9%, 81.7%, 63.3%, 60.0%). Most notably, all other Category B models score 0% on Faker, highlighting a unique emergent capability.

Table 2 demonstrates the effect of different training data compositions on performance on RSDPOM (which is a multimodal ML model optimized using the technology described herein) across multiple benchmarks, showing how various combinations of standard and reasoning-intensive data impact results with and without reasoning during inference.

Standard data refers to the baseline training dataset consisting of approximately 150,000 normal question-answer pairs generated through OmniChat using audio-visual captions, designed to teach fundamental multimodal perception and basic content understanding. Reasoning-intensive data refers to a specialized subset of approximately 30,000 challenging question-answer pairs specifically curated to require complex multi-step reasoning, created through a rigorous pipeline using ProVision for initial generation followed by OmniChat quality verification, with each pair having a minimum of 5-6 detailed reasoning steps to connect questions to answers.

TABLE 2

| Training Data | Inference Reasoning | AVBench | CasualTst | School | Funny |
|---|---|---|---|---|---|
| Full SFT data | X | 63.7% | 80.7% | 45.2% | 72.3% |
| Full SFT data | ✓ | 62.9% | 78.2% | 42.5% | 68.6% |
| w/o any reasoning | X | 63.2% | 81.0% | 44.1% | 71.1% |
| w/o reasoning-intensive part | X | 62.7% | 78.9% | 44.7% | 71.5% |
| w/o reasoning-intensive part | ✓ | 61.6% | 76.6% | 42.3% | 67.5% |
| Reasoning-intensive part only | ✓ | 58.8% | 75.2% | 40.1% | 63.5% |
| Full SFT data + pDPO | ✓ | 65.6% | 82.3% | 48.3% | 76.7% |

Table 2 reveals unexpected findings about training configurations. Direct answer generation initially outperforms reasoning approaches even with complete training data (63.7% vs 62.9% on AVBench, 80.7% vs 78.2% on CasualTst). This counter-intuitive result stems from exposure bias in teacher forcing, which affects longer reasoning sequences more severely than compact answers. After applying the optimization described herein, however, substantial improvements occur across all benchmarks as shown in Table 2.

Removing the reasoning-intensive portion while maintaining reasoning inference causes marked performance degradation. Scores drop to 61.6% on AVBench, 76.6% on CasualTst, 42.3% on School, and 67.5% on Funny. In contrast, using only reasoning-intensive data without general perception training results in even worse performance: 58.8% on AVBench and 75.2% on CasualTst. Through these comparisons, the necessity of both general multimodal perception capabilities and specialized reasoning training becomes evident.

Removing the complete reasoning-sequence direct-preference optimization component causes substantial accuracy decline: down to 44%, 78%, and 62% on key benchmarks. This represents a 16-38% relative performance drop compared to the results in Table 1. Additionally, experiments with varying rollout counts from 4 to 12 samples per step revealed diminishing returns beyond 6 rollouts. Based on these findings, 6 rollouts became the standard configuration for balancing accuracy and computational efficiency.

Performance data from contrastive step selection experiments reveals significant differences between three implementation approaches. The first approach, using only full reasoning paths for optimization, establishes baseline performance across benchmarks. On AVBench, this approach achieves approximately 62% accuracy. On Funny, accuracy reaches roughly 72%. For School, performance sits at approximately 44%.

The second approach combines full path optimization with selective optimization of the top three highest-divergence steps identified through contrastive analysis. This targeted strategy demonstrates consistent advantages across all benchmarks. AV Bench scores improve to approximately 66%, marking a 4-percentage point gain. Funny accuracy increases to about 77%, representing a 5-percentage point improvement. School results rise to roughly 48%, showing a 4-percentage point enhancement. These substantial gains highlight the value of focusing optimization efforts on carefully selected steps.

The third approach, applying optimization to every intermediate step alongside full paths, shows no additional benefit beyond the selective approach. In fact, slight performance decreases sometimes occur compared to the top-three strategy. AVBench scores remain at approximately 66%. Funny results show a marginal decline to about 76%. School benchmark performance stays near 48%. This pattern appears consistently across all evaluation categories.

From these results, several insights emerge. First, optimizing some intermediate steps significantly outperforms optimizing only complete paths. Second, the selection of specific high-divergence steps proves more effective than indiscriminate optimization of all steps. Finally, computational efficiency aligns with optimal performance when focusing exclusively on the most brittle reasoning steps. Indeed, these findings strongly validate the contrastive step selection methodology as both effective and efficient.

The following paragraphs further describe aspects of the present disclosure. A computing system is disclosed comprising processing circuitry and memory of a computing device operatively coupled to together, the memory storing multimodal content and the processing circuitry being configured to fine-tune a pre-trained multimodal reasoning-enhanced machine-learned (ML) model using portions of the memory storing instructions that, when executed, cause the processing circuitry to: using the ML model, produce a sequence of reasoning steps based on a question-answer pair about the multimodal content that connects the question to the answer, and select one or more original steps in the sequence of reasoning steps, each selected one or more original steps has a defined position in the sequence. The processing circuitry is further configured to, for each selected original step: based on the question-answer pair, produce one or more alternative steps that have a defined position in the sequence corresponding to an original step, wherein the one or more alternative steps and the corresponding original step form a step set; generate multiple rollouts for each step of the step set; determine success of each rollout; calculate a success rate of each step of the step set; compare the calculated success rate of the steps of the step set; assign a preferences relative to the steps of the step set based on the comparison of the calculated success rate thereof; and update the ML model to the preferences of the steps of the step set.

In this aspect, the multimodal content can include audio information and visual information, and the question-answer pair concerns aspects found in the audio information, visual information, or a combination thereof.

In this aspect, the preference assignment can include selection of a most successful step from amongst the steps of the step set and adjustment a highest preference to include the most successful step.

In this aspect, the selection of the one or more original steps can include substeps that: determine reasoning brittleness of steps of the sequence, wherein the reasoning brittleness of a step indicates a sensitivity of the step to changes in reasoning relative to changes in the multimodal content; and label one or more of the original steps as having most reasoning brittleness as the selected one or more original steps.

In this aspect, the selection of the one or more original steps can include substeps that: generate modified multimodal content by applying perturbations to the multimodal content; using the ML model, produce a set of modified reasoning steps based on the question-answer pair about modified multimodal content, wherein each modified step has a corresponding step in the sequence; compare the reasoning of the steps against the reasoning of the modified steps; determine a degree of change in reasoning of the steps against the modified steps; and label one or more of the original steps with a greatest degree of change as the selected one or more original steps.

In this aspect, the comparison of the reasoning and the determination of degree can include: computing a Kullback-Leibler divergence of reasoning results between the modified step and a corresponding step in the sequence.

In this aspect, the update of the ML model with the preferences can include: calculating reward scores for the steps of the step set; defining preference probabilities between each step of the step set; creating preference labels based on the success rates of the steps of the step set; computing preference mismatch penalties for comparisons between each step of the step set; combining the preference mismatch penalties into a loss function; calculating gradients of the loss function with respect to parameters of the ML model; and updating the parameters of the ML model using gradient descent to align with the preferences of the steps of the step set.

In this aspect, the multimodal content can include user-generated content having audio and video information.

In this aspect, the question-answer pair can be selected from a classification policy to facilitate classifying the multimodal content.

In this aspect the processing circuitry can be further configured to classify, detect, and/or understand the multimodal content based on the updated ML model.

In this aspect, the processing circuitry can be further configured to generate the sequences of steps employed to classify, detect, and/or understand the multimodal content, and the sequence of steps are based on the preferences of the steps of the step set.

In this aspect, the processing circuitry can be further configured to provide a user interface that displays the employed sequences of steps and an input mechanism for receiving input accepting or rejecting the employed sequence.

In this aspect, the processing circuitry can be further configured to perform an inference on multimodal content in response to receiving a prompt.

According to another aspect, a computerized method is disclosed comprising: using a pre-trained multimodal reasoning-enhanced machine-learned (ML) model, producing a sequence of reasoning steps based on a question-answer pair about multimodal content that connects the question to the answer, wherein the multimodal content includes audio information and visual information, wherein the question-answer pair concerns aspects found in the audio information, visual information, or a combination thereof. The method further comprises selecting one or more original steps in the sequence of reasoning steps, each selected one or more original steps has a defined position in the sequence. The method further comprises: for each selected original step: based on the question-answer pair, producing one or more alternative steps that have a defined position in the sequence corresponding to an original step, wherein the one or more alternative steps and the corresponding original step form a step set; generating multiple rollouts for each step of the step set; determining success of each rollout; calculating a success rate of each step of the step set; comparing the calculated success rate of the steps of the step set; assigning a preferences relative to the steps of the step set based on the comparison of the calculated success rate thereof; and updating the ML model to the preferences of the steps of the step set.

In this aspect, the selection of the one or more original steps can include: determining reasoning brittleness of steps of the sequence, wherein the reasoning brittleness of a step indicates a sensitivity of the step to changes in reasoning relative to changes in the multimodal content; and labeling one or more of the original steps as having most reasoning brittleness as the selected one or more original steps.

In this aspect, the selection of the one or more original steps can include: generating modified multimodal content by applying perturbations to the multimodal content; with the ML model, producing a set of modified reasoning steps based on the question-answer pair about modified multimodal content, wherein each modified step has a corresponding step in the sequence; comparing the reasoning of the steps against the reasoning of the modified steps; determining a degree of change in reasoning of the steps against the modified steps; and labeling one or more of the original steps with a greatest degree of change as the selected one or more original steps.

In this aspect, the updating of the ML model with the preferences can include substeps that: calculate reward scores for the steps of the step set; define preference probabilities between steps of the step set; create preference labels based on the success rates of the steps of the step set; compute preference mismatch penalties for comparisons between steps of the step set; combine the preference mismatch penalties into a loss function; calculate gradients of the loss function with respect to parameters of the ML model; and update the parameters of the ML model using gradient descent to align with the preferences of the steps of the step set.

In this aspect, the method can further comprise classifying, detecting, and/or understanding the multimodal content based on the updated ML model.

In this aspect, the method can further comprise generating the sequences of steps employed to classify, detect, and/or understand the multimodal content, the sequence of steps are based on the preferences of the steps of the step set.

According to another aspect, a computing system is disclosed comprising: processing circuitry and memory of a computing device operatively coupled to together, the memory storing audio and visual information as multimodal content and the processing circuitry being configured to fine-tune a pre-trained multimodal reasoning-enhanced machine-learned (ML) model using portions of the memory storing instructions that, when executed, cause the processing circuitry to: with the ML model, produce a sequence of reasoning steps based on a question-answer pair about the multimodal content that connects the question to the answer, wherein the multimodal content includes audio information and visual information, wherein the question-answer pair concerns aspects found in the audio information, visual information, or a combination thereof; select one or more original steps in the sequence of reasoning steps, each selected one or more original steps has a defined position in the sequence, wherein the selection of the one or more original steps includes: determine reasoning brittleness of steps of the sequence, wherein the reasoning brittleness of a step indicates a sensitivity of the step to changes in reasoning relative to changes in the multimodal content; and label one or more of the original steps as having most reasoning brittleness as the selected one or more original steps. The processing circuitry of the computing system may further be configured to: for each selected original step: based on the question-answer pair, produce one or more alternative steps that have a defined position in the sequence corresponding to an original step, wherein the one or more alternative steps and the corresponding original step form a step set; generate multiple rollouts for each step of the step set; determine success of each rollout; calculate a success rate of each step of the step set; compare the calculated success rate of the steps of the step set; assign a preferences relative to the steps of the step set based on the comparison of the calculated success rate thereof; and update the ML model to the preferences of the steps of the step set.

“And/or” as used herein is defined as the inclusive or ν, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
processing circuitry and memory of a computing device operatively coupled to together, the memory storing multimodal content and the processing circuitry being configured to fine-tune a pre-trained multimodal reasoning-enhanced machine-learned (ML) model using portions of the memory storing instructions that, when executed, cause the processing circuitry to:
using the ML model, produce a sequence of reasoning steps based on a question-answer pair about the multimodal content that connects the question to the answer;
select one or more original steps in the sequence of reasoning steps, each selected one or more original steps has a defined position in the sequence;
for each selected original step:
based on the question-answer pair, produce one or more alternative steps that have a defined position in the sequence corresponding to an original step, wherein the one or more alternative steps and the corresponding original step form a step set;
generate multiple rollouts for each step of the step set;
determine success of each rollout;
calculate a success rate of each step of the step set;
compare the calculated success rate of the steps of the step set;
assign a preferences relative to the steps of the step set based on the comparison of the calculated success rate thereof; and
update the ML model to the preferences of the steps of the step set.

2. The computing system of claim 1, wherein the multimodal content includes audio information and visual information, and the question-answer pair concerns aspects found in the audio information, visual information, or a combination thereof.

3. The computing system of claim 1, wherein the preference assignment includes selection of a most successful step from amongst the steps of the step set and adjustment a highest preference to include the most successful step.

4. The computing system of claim 1, wherein the selection of the one or more original steps includes:
determining reasoning brittleness of steps of the sequence, wherein the reasoning brittleness of a step indicates a sensitivity of the step to changes in reasoning relative to changes in the multimodal content; and
labelling one or more of the original steps as having most reasoning brittleness as the selected one or more original steps.

5. The computing system of claim 1, wherein the selection of the one or more original steps includes:
generating modified multimodal content by applying perturbations to the multimodal content;
using the ML model, producing a set of modified reasoning steps based on the question-answer pair about modified multimodal content, wherein each modified step has a corresponding step in the sequence;
comparing the reasoning of the steps against the reasoning of the modified steps;
determining a degree of change in reasoning of the steps against the modified steps; and
labelling one or more of the original steps with a greatest degree of change as the selected one or more original steps.

6. The computing system of claim 5, wherein the comparison of the reasoning and the determination of degree includes: computing a Kullback-Leibler divergence of reasoning results between the modified step and a corresponding step in the sequence.

7. The computing system of claim 1, wherein the update of the ML model with the preferences includes:
calculating reward scores for the steps of the step set;
defining preference probabilities between each step of the step set;
creating preference labels based on the success rates of the steps of the step set;
computing preference mismatch penalties for comparisons between each step of the step set;
combining the preference mismatch penalties into a loss function;
calculating gradients of the loss function with respect to parameters of the ML model; and
updating the parameters of the ML model using gradient descent to align with the preferences of the steps of the step set.

8. The computing system of claim 1, wherein the multimodal content includes user-generated content having audio and video information.

9. The computing system of claim 1, wherein question-answer pair is selected from a classification policy to facilitate classifying the multimodal content.

10. The computing system of claim 1, wherein the processing circuitry is further configured to classify, detect, and/or understand the multimodal content based on the updated ML model.

11. The computing system of claim 10, wherein the processing circuitry is further configured to generate the sequences of steps employed to classify, detect, and/or understand the multimodal content, and the sequence of steps are based on the preferences of the steps of the step set.

12. The computing system of claim 11, wherein the processing circuitry is further configured to provide a user interface that displays the employed sequences of steps and an input mechanism for receiving input accepting or rejecting the employed sequence.

13. The computing system of claim 1, wherein the processing circuitry is further configured to perform an inference on multimodal content in response to receiving a prompt.

14. A method comprising:
using a pre-trained multimodal reasoning-enhanced machine-learned (ML) model, producing a sequence of reasoning steps based on a question-answer pair about multimodal content that connects the question to the answer, wherein the multimodal content includes audio information and visual information, wherein the question-answer pair concerns aspects found in the audio information, visual information, or a combination thereof;
selecting one or more original steps in the sequence of reasoning steps, each selected one or more original steps has a defined position in the sequence;
for each selected original step:
based on the question-answer pair, producing one or more alternative steps that have a defined position in the sequence corresponding to an original step, wherein the one or more alternative steps and the corresponding original step form a step set;
generating multiple rollouts for each step of the step set;
determining success of each rollout;
calculating a success rate of each step of the step set;
comparing the calculated success rate of the steps of the step set;
assigning a preferences relative to the steps of the step set based on the comparison of the calculated success rate thereof; and
updating the ML model to the preferences of the steps of the step set.

15. The method of claim 14, wherein the selection of the one or more original steps includes:
determining reasoning brittleness of steps of the sequence, wherein the reasoning brittleness of a step indicates a sensitivity of the step to changes in reasoning relative to changes in the multimodal content; and
labeling one or more of the original steps as having most reasoning brittleness as the selected one or more original steps.

16. The method of claim 14, wherein the selection of the one or more original steps includes:
generating modified multimodal content by applying perturbations to the multimodal content;
with the ML model, producing a set of modified reasoning steps based on the question-answer pair about modified multimodal content, wherein each modified step has a corresponding step in the sequence;
comparing the reasoning of the steps against the reasoning of the modified steps;
determining a degree of change in reasoning of the steps against the modified steps; and
labeling one or more of the original steps with a greatest degree of change as the selected one or more original steps.

17. The method of claim 14, wherein the updating of the ML model with the preferences includes:
calculating reward scores for the steps of the step set;
defining preference probabilities between steps of the step set;
creating preference labels based on the success rates of the steps of the step set;
computing preference mismatch penalties for comparisons between steps of the step set;
combining the preference mismatch penalties into a loss function;
calculating gradients of the loss function with respect to parameters of the ML model; and
updating the parameters of the ML model using gradient descent to align with the preferences of the steps of the step set.

18. The method of claim 14 further comprising classifying, detecting, and/or understanding the multimodal content based on the updated ML model.

19. The method of claim 18 further comprising generating the sequences of steps employed to classify, detect, and/or understand the multimodal content, the sequence of steps are based on the preferences of the steps of the step set.

20. A computing system comprising:
processing circuitry and memory of a computing device operatively coupled to together, the memory storing audio and visual information as multimodal content and the processing circuitry being configured to fine-tune a pre-trained multimodal reasoning-enhanced machine-learned (ML) model using portions of the memory storing instructions that, when executed, cause the processing circuitry to:
with the ML model, produce a sequence of reasoning steps based on a question-answer pair about the multimodal content that connects the question to the answer, wherein the multimodal content includes audio information and visual information, wherein the question-answer pair concerns aspects found in the audio information, visual information, or a combination thereof;
select one or more original steps in the sequence of reasoning steps, each selected one or more original steps has a defined position in the sequence, wherein the selection of the one or more original steps includes:
determining reasoning brittleness of steps of the sequence, wherein the reasoning brittleness of a step indicates a sensitivity of the step to changes in reasoning relative to changes in the multimodal content; and
labeling one or more of the original steps as having most reasoning brittleness as the selected one or more original steps;
for each selected original step:
based on the question-answer pair, producing one or more alternative steps that have a defined position in the sequence corresponding to an original step, wherein the one or more alternative steps and the corresponding original step form a step set;
generating multiple rollouts for each step of the step set;
determining success of each rollout;
calculating a success rate of each step of the step set;
comparing the calculated success rate of the steps of the step set;
assigning a preferences relative to the steps of the step set based on the comparison of the calculated success rate thereof; and
updating the ML model to the preferences of the steps of the step set.
